(19) United States
(12) Patent Application Publication
(10) Pub. No.: US 2003/0128135 A1
(43) Pub. Date: Jul. 10, 2003

(54) Apparatus and method for providing for the remote control of traffic control devices along a travel route

(76) Inventor: Alexander I. Poltorak, Monsey, NY (US)

Correspondence Address: General Patent Corporation, Montebello Park, 75 Montebello Road, Suffern, NY, 10901, US

(21) Appl. No.: 10/328,767

(22) Filed: Dec. 24, 2002

Related U.S. Application Data
(60) Provisional application No. 60/341,579, filed on Jan. 10, 2002.

(51) Int. Cl. G08G 1/07

(52) U.S. Cl. 340/906

(57) ABSTRACT

An apparatus and method for remotely controlling a traffic control device, including an input device for inputting at least one of a control code and a command code corresponding to a control operation to be performed on a traffic control device, a processor for processing the at least one of a control code and a command code, wherein the processor generates a first control signal for performing a control operation on the traffic control device, and a transmitter for transmitting the first control signal to the traffic control device. The traffic control device receives the first control signal and generates a second control signal effectuating the control operation.

### FIELD OF THE INVENTION

The present invention pertains to an apparatus and method for providing for the remote control of traffic control devices along a travel route and, in particular, to an apparatus and method for providing for the remote control of traffic control devices from a vehicle traveling along a travel route.

### BACKGROUND OF THE INVENTION

Emergency service vehicles, such as, but not limited to, ambulances, police vehicle, fire vehicles and other various vehicles utilized by emergency services professionals, typically travel along roadways and streets which are utilized by drivers of other vehicles as well as pedestrians. There is no question that the response time of emergency services vehicles must be minimized and, therefore, the drivers or operators of these vehicles typically try to travel along a travel route which will result in the minimum travel time.

Travel time is also affected by the number of other vehicles which are traveling along the travel route, pedestrians attempting to cross or walk along the roadways or streets of a travel route, and the traffic control devices, such as, but not limited to, traffic lights, traffic signals, traffic control display devices, etc., which exist along a travel route. Typically these traffic control devices can serve as an effective means by which to control the movement of other vehicles as well as pedestrian traffic. As a result, traffic control devices can serve an important function in minimizing the travel time an effort of emergency services vehicles.

While traffic control devices can serve an important function in minimizing the travel time and efforts of emergency services vehicles, the operation of these traffic control devices is typically beyond the control of emergency services vehicles. The operation of these traffic control devices are typically pre-programmed and/or pre-set for certain operation or frequency of operation.

Notwithstanding the fact that a controlled operation of traffic control devices, in coordination with the location and travel of an vehicle along a travel route, could serve to minimize travel time an effort, there exists no apparatus, system, or method, which enables an emergency services vehicle to provide control over traffic control devices which exist along a travel route.

### SUMMARY OF THE INVENTION

The present invention pertains to an apparatus and method for providing for the remote control of traffic control devices along a travel route which overcomes the shortfalls of the prior art. The present invention pertains to an apparatus and method for providing for the remote control of traffic control devices along a travel route and, in particular, to an apparatus and method for providing for the remote control of traffic control from a vehicle traveling along a travel route.

The present invention can also be utilized so as to provide travel information and/or directions regarding a travel route from a present location, or a point of travel origin, to a destination. The present invention can also be utilized so as to provide optimal travel information and/or directions regarding a travel route from a present location, or a point of travel origin, to a destination. The travel information and/or directions can be utilized by a vehicle computer, by a driver or other operating individual, or by any passengers or occupants of the vehicle, in order to control or manipulate the operation of traffic control devices along the travel route, so as to minimize travel time and effort.

The present invention can also be utilized so as to provide travel information or directions in any area or areas for which map information, street or roadway information, and/or information regarding traffic control devices, signs, and/or signals, can be obtained and/or documented. The present invention can be utilized in urban areas, suburban areas, and/or rural areas, and/or in any combination of same.

The present invention can be utilized so as to provide travel information, instructions, or directions, in any area or areas for which map information, street or roadway information, and/or information regarding traffic control devices, signs, and/or signals, can obtained and/or documented.

The present invention can be utilized in order to provide information regarding the existence or a traffic control device or traffic control devices along a travel route or along an anticipated travel route, and the state of operation of the respective traffic control device or traffic control devices. The present invention can also be utilized to provide for the remote control of the respective traffic control device or traffic control devices along the route.

The present invention can be utilized to provide for the remote control of traffic control devices, as well as to provide travel information regarding travel in urban areas, suburban areas, and/or rural areas, and/or in any combination of same.

In this manner, the apparatus and method of the present invention can also be utilized by a vehicle operator or occupant in order to obtain driving information, traffic information, and/or driving directions and/or instructions, for driving a vehicle from a point of origin or a present location to a destination, as well as to provide the vehicle operator or occupant with the capability to control the operation of a traffic control device remotely and from the vehicle while the vehicle is traveling along the travel route.

The present invention can also provide directions and/or instructions regarding an optimal travel route, a travel route involving minimized travel time, and/or a travel route involving the minimum travel distance.

The present invention can provide in-vehicle information to a vehicle operator or occupant so as to allow the operator to be apprised of the existence and/or the operating state of a traffic control device or traffic control devices along a travel route as well as the existence and operating state of traffic control device or traffic control devices along a shortest or fastest travel route.

The present invention can be utilized in conjunction with vehicles of any type which can include, but which is not limited to, vehicles, motor vehicles, automobiles, buses, trucks, fire trucks, fire apparatus, ambulances, police cars, police van, armored vehicles, and/or any other vehicles or emergency services vehicles which can be utilized in conjunction with the apparatus and method of the present invention.

A vehicle, such as an emergency vehicle, can be equipped with a vehicle computer which can be installed and/or otherwise located in the vehicle. The vehicle computer can be utilized in order to provide remote control over the operation of a traffic control device. The vehicle computer can also provide travel information, instructions, and/or directions, regarding a travel route to an operator or occupants of the vehicle.

A central processing computer or server computer can also be utilized in order to facilitate communications and/or data transmissions between the vehicle computer and a traffic control device which is being remotely controlled by the vehicle computer. The vehicle computer can control a traffic control device or devices via the central processing computer. The central processing computer can also provide processing service and/or information to the vehicle operators or occupants which may be located in, or traveling in, a geographic area being serviced by the central processing computer or server computer.

The central computer can also provide processing service and/or provide information to vehicle operators or occupants of vehicles located in a given geographic service area. Any one or more of traffic control devices, traffic signs, etc., can also have a computer or computer system assigned thereto for facilitating bi-directional communications with the central processing computer or server computer and/or with any of the vehicle computers.

Any one or more of the traffic control devices, traffic signs, etc., which are utilized can have a computer or computer system assigned thereto for facilitating bi-directional communications with the central processing computer or server computer and/or with any of the vehicle computer.

The present invention can also be utilized to provide the operator of the vehicle or an occupant of the vehicle with driving directions or instructions for enabling the vehicle operator to travel from point A to Point B and/or for traveling from point A to Point B in the minimum amount of time, given possible alternate routes which exist between Point A and Point B, traffic regulations, current traffic, current traffic conditions, etc.

The present invention can also assess the possible routes which the vehicle operator can travel to Point B, determine which path would involve the projected shortest travel time and provide directions for the route having the shortest time to the vehicle operator.

At any time during the vehicle's travel from Point A to Point B, the apparatus and method of the present invention can be utilized in order to ascertain the present location of the vehicle, identify a traffic control device in the vicinity of the vehicle and in the vehicle's path, and determine the operating state of the traffic control device.

The apparatus of the present invention can include the vehicle computer which is associated with a vehicle or with a vehicle operator or occupant. The vehicle computer can be any type of computer or communication device which can provide or perform the control functionality and processing functionality described herein. The vehicle computer can be installed in the vehicle, can be removable or portably installed in the vehicle, and/or can be a mobile device which can be easily carried into and taken from the vehicle.

The apparatus can also include a central processing computer or server computer which can be a network computer, a server computer, an Internet server computer, a mainframe computer, and/or any other computer, computer system, any group or plurality of computers, and/or any group or plurality of computer systems, which can provide the control functionality and processing functionality described herein and which can provide the described servicing functionality to any number of vehicle computers. The vehicle computer can communicate with and/or obtain and/or process information received from the central processing computer.

The central processing computer can provide information to any one or more of the vehicle computers which can be located in a service area. The central processing computer can also have a web site, web sites, an IP address, and/or IP addresses, associated therewith.

The apparatus can also include one more traffic control devices which can, for example, be any one or more of a traffic light, a traffic signal light, a flashing light, a message display device, a traffic sign (i.e. stop sign, a yield sign, a warning sign, etc.), and/or a traffic control sign, and/or any combination of same.

Any of the vehicle computers, the central processing computer or computers, and the traffic control device computers, can communication with each other in a bi-directional manner. The operation of the traffic control devices can be controlled by the vehicle computer and/or by the vehicle computer via the central processing computer.

The apparatus of the present invention can be utilized on, over, and/or in conjunction with, any suitable communication network such as, but not limited to, a telecommunication network, the Internet, the World Wide Web, an RF signal communications network, a satellite communications network, an optical communications network, a public switched telephone network, a digital communications network, a personal communications services (PCS) communication network, and/or any other communication network or system, and/or any combination of same.

The central processing computer can provide service for any number of vehicle computers in a geographic area. The apparatus of the present invention can also be utilized in conjunction with any number of traffic control devices.

The vehicle computer can be any computer, computer system, and/or any suitably equipped communication device, having at least the components and peripheral devices described herein, which can be adapted for performing the control functionality and the processing routines and functionality described herein as being performed by the vehicle computer and/or the apparatus of the present invention.

The vehicle computer can also be utilized to perform any and/or all of the control functionality and processing routines described herein and for communicating with the central processing computer(s) and/or with any of the herein-described traffic control device(s) which are utilized in conjunction with the present invention.

The vehicle computer includes a central processing unit or CPU. The vehicle computer can also include a read only memory device(s), a random access memory device(s), a user input device, for entering data and/or commands into the vehicle computer, and a display for displaying data and/or information to a vehicle operator or occupant.

The vehicle computer can also include a transmitter(s) for transmitting signals and/or data and/or information to any of the herein-described traffic control devices and the central processing computer(s), and a receiver for receiving signals and/or data and/or information from any of the herein-described traffic control devices and the central processing computer(s).

The vehicle computer can also include a database(s) which can contain any and/or all of the data and/or information which may be needed and/or desired in performing the control functionality and processing routines described herein, such as, but not limited to those routines for providing control over the traffic control devices and routines for determining and providing any of the herein-described information, directions, and/or instructions, to the vehicle operator or occupant.

The data and/or information stored in the database(s) can be stored in, and be resident in, the database, can be obtained from, or loaded from, a compact disc (CD), a digital versatile disc (DVD), a magnetic tape, or any other storage medium. The information stored in the database can also be downloaded from the central processing computer(s) and/or any of the traffic control device(s).

The vehicle computer can also include a global positioning system (GPS) device which can be utilized for determining the position or location of the vehicle. The vehicle computer can also include an output device such as a printer, a modem, a fax/modem, or other output device, for providing data and/or information to the operator or occupant of the vehicle.

The vehicle computer can also include a voice synthesizing device system which can include at least a voice synthesizing device and associated speaker for providing audio voice information, directions, and/or instructions, to a vehicle operator or occupant(s). In this manner, voice synthesized driving information, directions, and/or instructions, can be provided to the operator or occupant of the vehicle.

The central processing computer can be any computer, computer system, network computer, server computer, and/or any suitably equipped communication device, having at least the components and peripheral devices described herein, which can be adapted for performing the control functionality and processing routines and functionality described herein as being performed by the central processing computer and/or the apparatus of the present invention. The central processing computer can be utilized in order to provide any and all of the control functionality and processing routines and functionality described herein for any number of vehicle computers and for any number of traffic control devices.

The central processing computer can be utilized to perform any and/or all of the control functionality and processing routines described herein and for communicating with any of the vehicle computers, with any of the herein-described traffic control device(s), and with any other central processing computer(s) which may be utilized.

The central processing computer includes a central processing unit or CPU. The central processing computer can also include a read only memory device(s) (ROM), a random access memory device(s), a user input device, for entering data and/or commands into the central processing computer, and a display device, for displaying data and/or information to an operator of the central processing computer.

The central processing computer can also include a transmitter(s), for transmitting signals and/or data and/or information to any of the herein-described traffic control devices and vehicle computers, which may be utilized. The central processing computer can also include a receiver, for receiving signals and/or data and/or information from any of the herein-described traffic control devices and vehicle computers, which may be utilized. The central processing computer can also transmit signals to, and receive signals from any of the other central processing computers which may be utilized.

The central processing computer can also include a database(s) which can contain any and/or all of the data and/or information which may be needed and/or desired in performing the control and processing routines described herein as being performed by the central processing computer, such as, but not limited to, routines for controlling any of the herein-described traffic control devices and routines for determining and providing any of the herein-described information, directions, and/or instructions, to any of the herein-described vehicle computers, and/or routines for facilitating communications and/or for interfacing with any of the vehicles computers, with any of the traffic control devices, and/or with any other central processing computers which may be utilized.

The data and/or information stored in the database can be stored in, and be resident in, the database, can be obtained from, or loaded from, any number of compact discs (CDs), digital versatile discs (DVDs), magnetic tapes, or any other storage mediums. The information stored in the database can also be downloaded from other central processing computer(s) and/or from any of the traffic control device(s) which may be utilized.

The central processing computer can also include an output device, for providing data and/or information to the operator of the central processing computer.

The traffic control device can be any traffic control device, traffic light, display device, message display device, or traffic sign, capable of having a processing functionality. The traffic control device can be, or can include, a computer, computer system, network computer, server computer, and/or any suitably equipped communication device, along with the functional devices of the respective traffic control device (i.e. traffic lights, message displays, blinking lights, etc.) and can further have any other components and peripheral devices described herein, which can be adapted for performing the control functionality and processing routines and functionality described herein as being performed by the traffic control device and/or the apparatus of the present invention.

The traffic control device can be utilized to perform any and/or all of the control functions, processing routines and traffic control functions, described herein and for communicating with any of the vehicle computers, with any of the central processing computers, and with any other traffic control devices, which may be utilized with the present invention.

The traffic control device can include a central processing unit or CPU. The traffic control device can also include a read only memory device(s) (ROM), a random access memory device(s) (RAM), a user input device, for entering data and/or commands into the traffic control device, and a display device, for displaying data and/or information to an operator of the traffic control device.

The traffic control device can also include the traffic control equipment which is associated with the traffic control device and which can be or can include a respective traffic light, a flashing or blinking light, a traffic message display device, a controllable traffic sign, or any other equipment which can be associated with, or utilized in conjunction with, a respective traffic control device.

The traffic control device can also include a traffic speed sensor or sensing device which can be, or which can include, any one or more of the well known electrical sensors, optical sensors, laser sensors, mechanical sensors, or pneumatic sensors, which can be utilized for determining the speed of vehicles along a road or street, or through an intersection.

The traffic speed sensor can also utilize radar signals or optical signals to determine the speed(s) of vehicles. The traffic speed sensor can also be any suitable device for counting the number of vehicles which travel past a pre-determined point in a pre-specified time interval, which can be utilized to determine an average speed of traffic flow.

The traffic control device can also include a transmitter(s), for transmitting signals and/or data and/or information to any one or more of the vehicle computers, to the central processing computer(s), and/or to any other traffic control device(s) which may be utilized.

The traffic control device can also include a receiver, for receiving signals and/or data and/or information from any of the vehicle computers, from the central processing computer(s), and/or from any other traffic control device(s) which may be utilized.

The traffic control device can also include a database(s) which can contain any and/or all of the data and/or information which may be needed and/or desired in performing the control functionality and processing routines described herein as being performed by the traffic control device, such as, but not limited to, routines for controlling the operation of the traffic control device and for controlling traffic control signal light activation, message generation and/or display, and any other operations performed by, or capable of being performed by, the respective traffic control device.

The data and/or information stored in the database can be stored in, and be resident in, the database, can be obtained from, or loaded from, any number of compact discs (CDs), digital versatile discs (DVDs), magnetic tapes, or any other storage mediums, and/or can also be downloaded from other central processing computer(s) and/or from any of the traffic control device(s) which may be utilized.

The traffic control device can also include an output device for providing data and/or information to the operator or occupant of the traffic control device.

The present invention can be utilized in a number of embodiments in order to provide remote control of traffic control devices and/or to provide driving information, directions, and/or instructions, to a vehicle operator or occupant.

In one embodiment, the present invention can operate in a “stand alone” embodiment wherein the vehicle computer can perform a remote control of a traffic control device or devices. The vehicle computer can perform all of the processing routines and/or functionality which can be provided by the present invention.

In another embodiment, the present invention can be utilized, and can operate, on an on-line environment, wherein the vehicle computer can perform a remote control of a traffic control device or traffic control devices via the central processing computer.

The present invention can also be utilized in a number of embodiments in order to provide driving information, directions, and/or instructions, to a vehicle operator or occupant while also providing for the remote control of traffic control devices along a travel route.

In any of the described embodiments, the present invention can be utilized in a vehicle computer “stand-alone” mode or in an on-line mode wherein the vehicle computer can be utilized in conjunction with the central processing computer. In a vehicle computer “stand alone” embodiment, the vehicle computer can perform all of the processing routines and/or functionality which can be provided by the present invention.

In a “stand alone” embodiment, the vehicle computer can utilize data and/or information which is stored in its database, and/or which is obtained from a compact disc (CD), a digital video disc (DVD), a magnetic or other tape, and/or any other storage media, in order to provide for the remote control of traffic control devices and to provide driving information, directions, and/or instructions, for directing the vehicle operator or occupant from a present or known location to a pre-determined or pre-selected destination via an optimal travel route.

In a “stand alone” embodiment, the vehicle computer can utilize data and/or information which is stored in its database and/or data and/or information which can be obtained from a traffic control device(s). The vehicle computer can also process information which can be stored on, or which can be obtained from, a compact disc (CD), a digital video disc (DVD), a magnetic or other tape, and/or any other storage media capable of being utilized by the vehicle computer.

In a vehicle computer “stand alone” embodiment, a traffic control device along the vehicle's travel route, which is to be controlled, can be identified by any appropriate method. Control code information and/or command code information can then be entered into the vehicle computer for controlling the operation of the identified traffic control device. A control signal, control code, and/or command code, corresponding to the control code or command code, can then be transmitted from the vehicle computer to, and received by, the traffic control device. The traffic control device can process the control signal, control code, and/or command code, and generate a control signal for effecting the desired operation of the traffic control device. Thereafter, the traffic control device can effect the desired operation.

In an “on-line” environment, the vehicle operator or occupant can access the central processing computer with the vehicle computer. The traffic control device, which is to be controlled, can then be identified by any number of methods.

Control code information and/or command code, for controlling the operation of the identified traffic control device, can be entered into the vehicle computer and transmitted to the central processing computer.

The central processing computer can receive and process the received control signal, control code, and/or command code, identify the traffic control device which is to be controlled, identify the operation or function to controlled, and generate a second control signal, control code, and/or command code.

The second control signal, control code, and/or command code, can then be transmitted from the central processing computer to the traffic control device. The traffic control device can receive and process the second control signal, control code, and/or command code, and generate a control signal for effecting the desired operation of the traffic control device. The traffic control device then can effect the desired operation.

The present invention can also be utilized in a “stand alone” embodiment in order to provide driving information, directions, and/or instructions, for directing the vehicle operator or occupant from a present or known location to a pre-determined or pre-selected destination via an optimal travel route, and can also provide for the remote control of traffic control devices along the travel route.

The travel route can be, but need not be, an optimal ravel route. An optimal travel route can be the route traveled in the shortest amount of time, the route having the fewest or minimum number of turns along a travel route to a destination, the route having the fewest or minimum number of traffic lights, traffic signs or other traffic control devices encountered along a travel route to a destination, the route having the fewest or minimum number of travel encumbrances (i.e. road work, construction, accidents, bridges, tolls, etc.) encountered along a travel route to a destination, and/or any other criteria.

The vehicle computer can identify any number of optimal travel routes as it is recognized that oftentimes two or more travel routes may qualify as optimal travel routes.

The vehicle operator or occupant can enter information regarding the present location of the vehicle into the vehicle computer either manually, via a user input device, or automatically, via the global positioning system device. The destination information can also be entered by the vehicle operator or occupant into the vehicle computer.

The vehicle computer can identify all possible travel routes from a present location to the destination. The vehicle computer can also determine the travel distance along each road or street, or segment thereof, for each leg of a travel route for each of the identified possible travel routes. The vehicle computer can also identify intersections which exist along each of the possible travel routes, along with identifying the existence of traffic control devices, traffic lights, traffic signals, etc., which exist along a travel route, for each of the possible travel routes.

The vehicle computer can process the information regarding the possible travel routes and determine the optimal travel route or optimal travel routes.

In one embodiment the vehicle computer can determine the optimal travel route or routes by utilizing information stored in the database which does not include the states of any of the various traffic control devices which may exist in a geographic area. In this manner, the present invention can determine an optimal travel route or routes in instances when green light on and off times for a traffic light or traffic lights along possible travel routes are not known.

In another embodiment, the states of any of the various traffic control devices, which may exist in a geographic area, can be known and can be pre-stored in the database of the vehicle computer. In this manner, the optimal travel route or routes can be determined by utilizing information regarding the time or times at which a traffic light turns green and the duration of the green light, for each traffic light or traffic lights along the possible travel routes.

The vehicle computer can also determine the optimal travel route or routes by generating and solving an equation representing the expected travel time along each of the possible travel routes. In instances when all relevant information is known or estimations of same are available, the present invention can calculate the travel time for each one of the possible travel routes. In instances, where unknown parameters exist, the present invention can solve a group of equations simultaneously by utilizing linear programming techniques or other techniques.

The vehicle computer can determine the optimal travel route or routes from the identified possible travel routes. The present invention can then compile the information regarding the travel directions and/or instructions regarding the optimal travel route.

The travel route information can then be provided to the vehicle operator or occupant, via the vehicle computer, by any one or more of displaying the travel directions or instructions on the display device, outputting the travel directions or instructions on the output device, or providing audible travel directions or instructions via the voice synthesizing device system.

The vehicle operator or occupant can, thereafter, utilize the vehicle computer remotely control the operation of traffic control devices along the travel route when and if desired.

In another embodiment, the vehicle computer can be utilized in conjunction with the central processing computer(s) and/or with any one or more of the traffic control devices which are utilized in conjunction with the present invention in order to provide driving information, directions, and/or instructions, for directing the vehicle operator or occupant from a present or known location to a pre-determined or pre-selected destination via an optimal travel route, and can also provide for the remote control of traffic control devices along the travel route. The travel route can be, but need not be, an optimal ravel route.

The vehicle operator or occupant can access the central processing computer via the vehicle computer. The vehicle operator or occupant can enter information regarding the present location of the vehicle into the vehicle computer either manually, via the user input device, or automatically, via the global positioning system device. The present location information can then by transmitted to and received by the central processing computer.

The vehicle operator or occupant can then enter information regarding the desired destination into the vehicle computer. The destination information can also be transmitted from the vehicle computer to and received by the central processing computer.

The central processing computer can then process and store the present location or position information and the destination information. The central processing computer can identify all possible travel routes from a present location to the destination.

The central processing computer can also determine the travel distance along each road or street, or segment thereof, for each leg of a travel route for each of the identified possible travel routes. The central processing computer can also identify intersections which exist along each of the possible travel routes and can also identify the existence of traffic control devices, traffic lights, traffic signals, etc., which exist along a travel route, for each of the possible travel routes.

The central processing computer can process the information regarding the possible travel routes and determine the optimal travel route or optimal travel routes. The central processing computer can utilize data and/or information which may be stored in its database or can obtain any needed and/or desired information such as, for example, a traffic control device green light on-time and green light on duration, traffic speed through, or at, an intersection or road section in the vicinity of a traffic control device, by accessing and obtaining the information from a respective traffic control device(s) which is/are identified as being on the identified possible travel route or travel routes.

The central processing computer(s) and the traffic control devices can be capable of communicating with each other in a bi-directional manner. In this regard, the central processing computer can obtain any of the needed data and/or information from a respective traffic control device, in real-time and/or otherwise.

In one embodiment, the central processing computer can determine the optimal travel route or routes by utilizing information which may or may not include information regarding the states of any of the various traffic control devices which may exist in a geographic area. In another embodiment, the central processing computer can obtain any missing and/or desired information directly from a respective traffic control device(s) and/or from any other central processing computer(s) which may be utilized in conjunction with the present invention.

In an embodiment where certain data and/or information is not available to the central processing computer and/or the central processing computer cannot obtain same from an external source, the optimal travel route or routes can be determined by the central processing computer by using estimated and/or stored estimations. In another embodiment, the states of any of the various traffic control devices, which may exist in a geographic area, can be known and can be pre-stored in the database of the central processing computer.

The central processing computer can determine the optimal travel route or routes by generating an equation representing the expected travel time along each of the possible travel routes. The central processing computer can utilize the same or similar processing algorithms which may be utilized by the vehicle computer in determining and identifying an optimal travel route.

The central processing computer can determine the equations for each of the possible travel routes. The central processing computer can than solve the equations to identity the optimal travel route. In an embodiment where no information regarding the on times or on duration for a green light of a traffic signal(s) is known or stored, but where an estimated average travel time though an intersection or road segment having such a traffic signal(s) is known, the central processing computer can calculate the estimated travel times for each of the possible travel routes.

In another embodiment, where on times and duration of green lights are known, the amount of time spent at an intersection or road section having the traffic light can be estimated by calculating the estimated time of arrival at the respective intersection or road section and then determining whether the light would be green or the amount of time which would have to elapse until the light turns green. In this manner, the time to travel through the intersection can be estimated.

In another embodiment, where no information regarding the on times or on duration for a green light of a traffic signal(s) is known or stored, and no estimated average travel time though an intersection or road segment having such a traffic signal(s) is available, the unknown information can be represented by an unknown variable and the central processing computer can solve the group of equations by utilizing linear programming techniques or other techniques.

The central processing computer can then identify the optimal travel route to the destination and compile the information regarding the travel directions and/or instructions regarding the optimal travel route. The central processing computer can then transmit the optimal travel route information to the vehicle computer.

The vehicle computer can receive the optimal travel route information. The optimal travel route information can then be provided to the vehicle operator or occupant, via the vehicle computer, by any one or more of displaying the travel directions or instructions on the display device, outputting the travel directions or instructions via the output device, or providing audible travel directions or instructions via the voice synthesizing device system.

The vehicle operator or occupant can, thereafter, utilize the vehicle computer remotely control the operation of traffic control devices along the travel route when and if desired.

The present invention can automatically detect a traffic control device and its operational state. If the operating state is determined to be in a state which may require a change of operating state or which may dictate a control of same, the present invention can automatically control the traffic control device by transmitting an appropriate control signal, control code, and/or command code to the traffic control device and/or to the central processing computer.

If the control signal, control code, and/or command code, is transmitted from the vehicle computer to the central processing computer, the central processing computer can also automatically transmit the second control, control code, and/or command code, to the traffic control device.

The present invention can also automatically determine a vehicle position and an operating state of a traffic control device which is being approached by the vehicle. The present invention can then automatically control the traffic control device so as to minimize any delay to the vehicle's travel.

The present invention can also generate an information request message and transmit same to a traffic control device(s) in order to obtain operating characteristic information such as, green light on time or times, green light on time schedule or schedules, and/or green light on time duration or durations, from the respective device(s).

The respective traffic control device or devices can receive the request, process same, and generate a response message which can be transmitted to the requesting computer and be utilized in performing any of the herein-described processing routines and/or functionality.

Accordingly, it is an object of the present invention to provide an apparatus and method for remotely controlling a traffic control device.

It is another object of the present invention to provide an apparatus and method for remotely controlling a traffic control device from a vehicle.

It is still another object of the present invention to provide an apparatus and method for remotely controlling a traffic control device from a vehicle.

It is yet another object of the present invention to provide an apparatus and method for remotely controlling a traffic control device from a vehicle which is traveling along a travel route.

It is another object of the present invention to provide an apparatus and method for remotely controlling a traffic control device which can provide travel information, directions, and/or instructions.

It is still another object of the present invention to provide an apparatus and method for remotely controlling a traffic control device which can provide travel information, directions, and/or instructions, regarding a travel route to a destination.

It is yet another object of the present invention to provide an apparatus and method for remotely controlling a traffic control device which can provide travel information, directions, and/or instructions, regarding a an optimal travel route to a destination.

It is another object of the present invention to provide an apparatus and method for remotely controlling a traffic control device which can provide travel information, directions, and/or instructions, to a destination, and which can provide for the control and/or manipulation of the operation of traffic control devices along the travel route.

It is still another object of the present invention to provide an apparatus and method for remotely controlling a traffic control device which can provide travel information, directions, and/or instructions, to a destination, along with information regarding a state of operation of a respective traffic control device or traffic control devices along the travel route.

It is yet another object of the present invention to provide an apparatus and method for remotely controlling a traffic control device which can provide travel information, directions, and/or instructions, regarding an optimal travel route to a destination.

It is another object of the present invention to provide an apparatus and method for remotely controlling a traffic control device which can provide travel information, directions, and/or instructions, regarding an a travel route involving minimized travel time, and/or a travel route involving the minimum travel distance.

It is still another object of the present invention to provide an apparatus and method for remotely controlling a traffic control device which can provide in-vehicle travel information, directions, and/or instructions, regarding a travel route.

It is yet another object of the present invention to provide an apparatus and method for remotely controlling a traffic control device which can be utilized in conjunction with vehicles of any type.

It is another object of the present invention to provide an apparatus and method for remotely controlling a traffic control device which can be utilized in conjunction with any one or more of motor vehicles, automobiles, buses, trucks, fire trucks, fire apparatus, ambulances, police cars, police van, armored vehicles, and/or any other vehicles or emergency services vehicles.

It is still another object of the present invention to provide an apparatus and method for remotely controlling a traffic control device which can be utilized in conjunction with any suitable communication network.

It is yet another object of the present invention to provide an apparatus and method for remotely controlling a traffic control device which can be utilized in conjunction with any one or more of the Internet, the World Wide Web, an RF signal communications network, a satellite communications network, an optical communications network, a public switched telephone network, a digital communications network, a personal communications services (PCS) communication network, and/or any other communication network or system, and/or any combination of same.

It is another object of the present invention to provide an apparatus and method for remotely controlling a traffic control device which provide service for any number of vehicle computers in a geographic area.

It is still another object of the present invention to provide an apparatus and method for remotely controlling a traffic control device with a vehicle computer.

It is yet another object of the present invention to provide an apparatus and method for remotely controlling a traffic control device with a vehicle computer via a central processing computer.

It is another object of the present invention to provide an apparatus and method for remotely controlling a traffic control device which can be utilized to identify a traffic control device which is to be controlled.

It is still another object of the present invention to provide an apparatus and method for remotely controlling a traffic control device which can be effectuate a control of a traffic control device by utilizing a control signal, a control code, and/or a command code.

It is yet another object of the present invention to provide an apparatus and method for remotely controlling a traffic control device which can detect a traffic control device and its operational state.

It is another object of the present invention to provide an apparatus and method for remotely controlling a traffic control device which can automatically control a traffic control device.

It is still another object of the present invention to provide an apparatus and method for remotely controlling a traffic control device which can automatically determine a vehicle position and an operating state of a traffic control device which is being approached by the vehicle.

It is yet another object of the present invention to provide an apparatus and method for remotely controlling a traffic control device which can obtain operating information from a traffic control device.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the drawings:

FIG. 1 illustrates a road map of an exemplary area in which the apparatus and method of the present invention can be utilized;

FIG. 2 illustrates a preferred embodiment of the apparatus of the present invention, in block diagram form;

FIG. 3 illustrates the vehicle computer of FIG. 2, in block diagram form;

FIG. 4 illustrates the central processing computer of FIG. 2, in block diagram form;

FIG. 5 illustrates the traffic control device of FIG. 2, in block diagram form;

FIG. 6 illustrates a preferred embodiment method of utilizing the apparatus of the present invention, in flow diagram form;

FIG. 7 illustrates another preferred embodiment method of utilizing the apparatus of the present invention, in flow diagram form;

FIG. 8 illustrates a yet another preferred embodiment method of utilizing the apparatus of the present invention, in flow diagram form; and

FIGS. 9A and 9B illustrate still another preferred embodiment method of utilizing the apparatus of the present invention, in flow diagram form.

### DESCRIPTION OF THE PREFERRED EMBODIMENTS

The present invention pertains to an apparatus and method for providing for the remote control of traffic control devices along a travel route which overcomes the shortfalls of the prior art. The present invention pertains to an apparatus and method for providing for the remote control of traffic control devices along a travel route and, in particular, to an apparatus and method for providing for the remote control of traffic control from a vehicle traveling along a travel route.

The present invention can also be utilized so as to provide travel information and/or directions regarding a travel route from a present location, or a point of travel origin, to a destination. The present invention can also be utilized so as to provide optimal travel information and/or directions regarding a travel route from a present location, or a point of travel origin, to a destination.

The travel information and/or directions can be utilized by a vehicle computer, by a driver or other operating individual, or by any passengers or occupants of the vehicle, in order to control or manipulate the operation of traffic control devices along the travel route. In this manner, the apparatus and method of the present invention can be utilized to minimize travel time and effort.

The present invention can also be utilized so as to provide travel information or directions in any area or areas for which map information, street or roadway information, and/or information regarding traffic control devices, signs, and/or signals, can be obtained and/or documented. The present invention can be utilized in urban areas, suburban areas, and/or rural areas, and/or in any combination of same.

The apparatus and method of the present invention can be utilized so as to provide travel information, instructions, or directions, in any area or areas for which map information, street or roadway information, and/or information regarding traffic control devices, signs, and/or signals, can obtained and/or documented.

The apparatus and method of the present invention can be utilized in order to provide information regarding the existence or a traffic control device or traffic control devices along a travel route or along an anticipated travel route, and the state of operation of the respective traffic control device or traffic control devices.

The apparatus and method of the present invention can then be utilized to provide for the remote control of the respective traffic control device or traffic control devices along the route. As an illustrative example, the apparatus and method of the present invention can be utilized to provide information to a vehicle computer located in, for example, an ambulance, a fire truck, or a police car.

The apparatus and method of the present invention can determine travel route information from present location information and destination information. The apparatus and method of the present invention can identify the existence of a traffic control device, such as a traffic light containing at least one green light and a red light, determine the state of the traffic control device (i.e. whether the light is green is on allowing travel in the direction of travel of the vehicle, whether the light is red is on prohibiting travel in the direction of travel of the vehicle, etc.), and if the traffic control device is operating in a state (i.e. red light on) which is not consistent with the ability of the vehicle to travel along a travel route, the apparatus and method of the present invention can provide for the remote control of the traffic control device so as to change the operating state to green light on thereby enabling the vehicle to continue traveling along the route without delay caused by having to maneuver past a section of a roadway or intersection containing the traffic control device.

In this manner, the apparatus and method of the present invention can be utilized to enable a vehicle computer to remotely control a traffic control device or traffic control devices which may exist along a travel route.

The apparatus and method of the present invention can be utilized to provide for the remote control of traffic control devices, as well as to provide travel information regarding travel in urban areas, suburban areas, and/or rural areas, and/or in any combination of same.

In this manner, the apparatus and method of the present invention can also be utilized by a vehicle operator or occupant in order to obtain driving information, traffic information, and/or driving directions and/or instructions, for driving a vehicle from a point of origin or a present location to a destination, as well as to provide the vehicle operator or occupant with the capability to control the operation of a traffic control device remotely and from the vehicle while the vehicle is traveling along the travel route.

The apparatus and method of the present invention can also provide directions and/or instructions regarding an optimal travel route, a travel route involving minimized travel time, and/or a travel route involving the minimum travel distance.

In this manner, the apparatus and method of the present invention can provide in-vehicle information to a vehicle operator or occupant so as to allow the operator to be apprised of the existence and/or the operating state of a traffic control device or traffic control devices along a travel route as well as the existence and operating state of traffic control device or traffic control devices along a shortest or fastest travel route.

The apparatus and method of the present invention can be utilized in conjunction with vehicles of any type which can include, but which is not limited to, vehicles, motor vehicles, automobiles, buses, trucks, fire trucks, fire apparatus, ambulances, police cars, police van, armored vehicles, and/or any other vehicles or emergency services vehicles which can be utilized in conjunction with the apparatus and method of the present invention.

It is important to note that while the present invention is described as being utilized in conjunction with a vehicle or an emergency vehicle, the present invention can be utilized in conjunction with any type of vehicles, including, but not limited to, emergency vehicles as well as non-emergency vehicles.

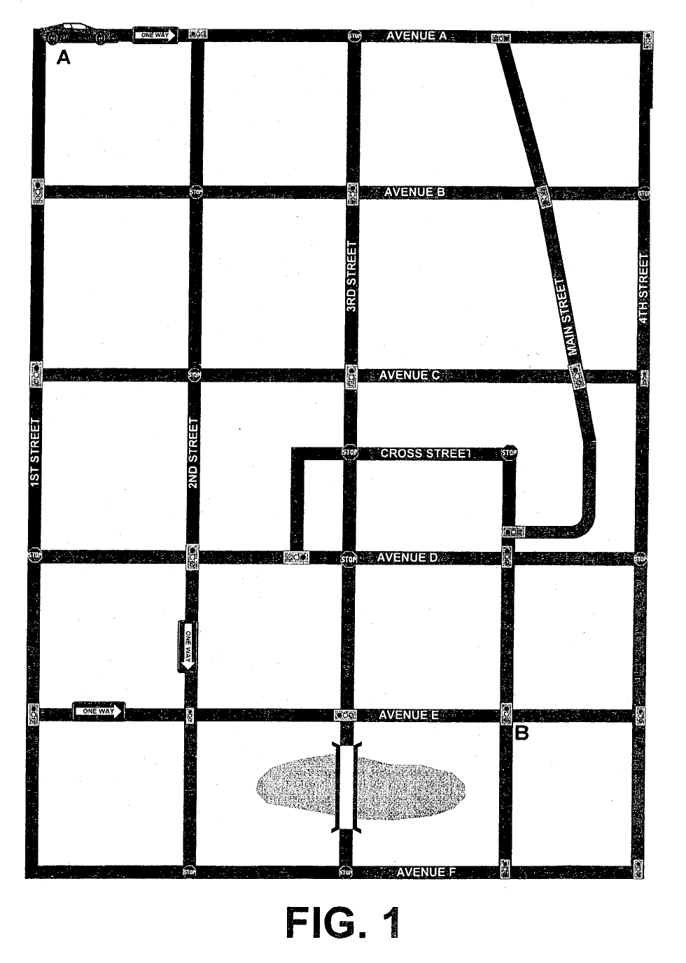

FIG. 1 illustrates a road map of an exemplary area in which the apparatus and method of the present invention can be utilized. It is important to note, however, that the apparatus and method of the present invention can be utilized in conjunction with any type of area or travel area for which any of the data and/or information, described herein as being needed for the operation of the present invention, can be obtained and/or documented.

With reference to FIG. 1, a road map is illustrated showing an emergency vehicle or vehicle 10, in which a vehicle computer (not shown) is utilized, traveling from a starting point A to a destination B. As is illustrated in FIG. 1, the area depicted therein illustrates the various roads, intersections, traffic control devices, including, but not limited to, traffic lights, stops sign, as well as other traffic control devices (not shown), which are located in the area.

As will be described in further detail below, the emergency vehicle or vehicle 10 will have a vehicle computer (not shown) which is installed therein and/or otherwise located therein or thereat. The vehicle computer, as described hereinbelow can be utilized in order to provide remote control over the operation of a traffic control device. As will be further described hereinbelow, the vehicle computer can also be utilized to provide travel information, directions, and/or instructions, to the vehicle operator to occupant regarding a travel route from a present location to a destination.

A central processing computer or server computer (not shown) can also be utilized, in a preferred embodiment, in order to facilitate communications and/or data transmissions between the vehicle computer and a traffic control device which is being remotely controlled by the vehicle computer. The central processing computer can also provide processing service and/or information to the vehicle operators or occupants which may be located in, or traveling in, a geographic area being serviced by the central processing computer or server computer.

In a preferred embodiment, any one or more of the traffic control devices, traffic signs, etc., can have a computer or computer system assigned thereto for facilitating bi-directional communications with the central processing computer or server computer and/or with any of the vehicle computers.

As will be described herein, the apparatus and method of the present invention can be utilized in order to provide for the remote control of traffic control devices by a vehicle computer located in the vehicle. The apparatus and method of the present invention can also be utilized to provide the operator of the vehicle or an occupant of the vehicle with driving directions or instructions for enabling the vehicle operator to travel from point A to Point B and/or for traveling from point A to Point B in the minimum amount of time, given possible alternate routes which exist between Point A and Point B, traffic regulations, current traffic, current traffic conditions, etc.

The apparatus and method of the present invention can also assess the possible routes which the vehicle operator can take to go to Point B, determine which path would involve the projected shortest travel time and provide directions for the route having the shortest time to the vehicle operator.

At any time during the vehicle's travel from Point A to Point B, the apparatus and method of the present invention can be utilized in order to ascertain the present location of the vehicle, identify a traffic control device in the vicinity of the vehicle and in the vehicle's path, determine the operating state of the traffic control device. For example, the apparatus and method of the present invention can determine if the green light of a traffic light is “on” designating that the vehicle can continue on the without having deal with traveling through an intersection with a red light, or that the red light of the traffic light is “on” designating the vehicle should exercise a remote control function in order to change the traffic light operation to turn the red light “off” and to turn the green light “on”.

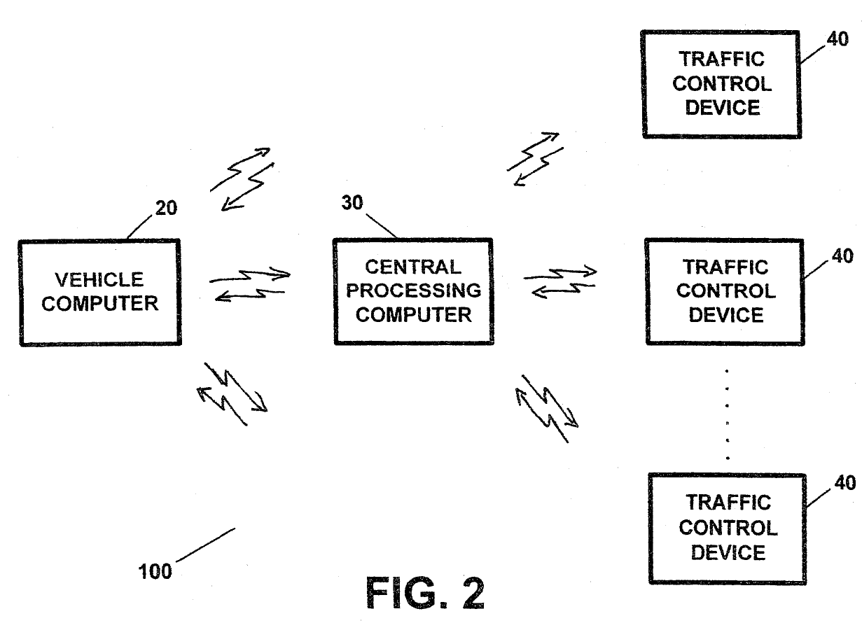

FIG. 2 illustrates a preferred embodiment of the apparatus of the present invention, in block diagram form. The apparatus of FIG. 2 is designated generally by the reference numeral 100. With reference to FIG. 2, the apparatus 100 includes the vehicle computer 20 which is associated with a vehicle or with a vehicle operator or occupant. The vehicle computer 20 can be any type of computer or communication device which can provide, or which can perform, the functionality described herein.

In a preferred embodiment, the vehicle computer 20 can be installed in the vehicle, can be removable or portably installed in the vehicle, and/or can be a mobile device which can be easily carried into and from the vehicle. The vehicle computer 20 can be a self-contained and fully integrated device which can be capable of performing any and/or all of the remote control functions, the processing routines, and/or the functionality, described herein as being performed by the apparatus and method of the present invention.

With reference to FIG. 2, the apparatus 100 can also include a central processing computer or server computer 30 (hereafter referred to as “central processing computer 30”). The central processing computer 30 can be a network computer, a server computer, an Internet server computer, a mainframe computer, and/or any other computer, computer system, any group or plurality of computers, and/or any group or plurality of computer systems, which can provide the remote control functions in conjunction with the vehicle computer, and any of the processing functionality described herein, for any number of vehicle computers 20.

In the preferred embodiment, the vehicle computer 20 can communicate with and/or transmit remote control commands to the traffic control devices via the central processing computer 30. In another preferred embodiment, the vehicle computer 20 can also transmit remote control commands over a communication network to the traffic control devices. The vehicle computer 20 can also obtain and/or process information received from the central processing computer 30 and/or the traffic control devices.

The central processing computer 30 can provide information to any one or more of the vehicle computers 20 which can be located in a service area. The central processing computer 30 can also have a web site or web sites associated therewith. The central processing computer 30 can also have an IP address or IP addresses assigned thereto.

The apparatus 100 can also include one more traffic control devices 40. The traffic control devices 40 can be any one more of a traffic light, a traffic signal light, a flashing light, a message display device, a traffic sign (i.e. stop sign, a yield sign, a warning sign, etc.), and/or a traffic control sign, and/or any combination of same.

Any of the vehicle computers 20, the central processing computer or computers 30, and the traffic control devices 40, can communication with one other in a bi-directional manner. Any of the traffic control devices 40 can also can also have an IP address assigned thereto and/or associated therewith and/or a web site assigned thereto and/or associated therewith.

The apparatus 100 of FIG. 2, in the preferred embodiment, can be utilized on, over, and/or in conjunction with, any suitable communication network such as, but not limited to, a telecommunication network, the Internet, the World Wide Web, an RF signal communications network, a satellite communications network, an optical communications network, a public switched telephone network, a digital communications network, a personal communications services (PCS) communication network, and/or any other communication network or system, and/or any combination of same.

As noted above, in the embodiment of FIG. 2, the vehicle computer 20 can communicate with the central processing computer 30 in a bi-directional manner. In this manner, the vehicle computer 20 can transmit signals to, and receive signals from, the central processing computer 30. The central processing computer 30 can also transmit signals to, and receive signals from, the vehicle computer 20.

The central processing computer 30 can also transmit signals to, and receive signals from, any one or more of the traffic control devices 40 utilized in conjunction with the present invention. The vehicle computer 20 can also transmit signals to, and receive signals from, any of the one or more traffic control devices 40. The traffic control devices 40 can also transmit signals to, and receive signals from, the central processing computer 30 and the vehicle computer 20.

In the preferred embodiment, the central processing computer 30 can provide service for any number of vehicle computers 20 in a geographic area. In the preferred embodiment, the apparatus can include any number of traffic control devices 40.

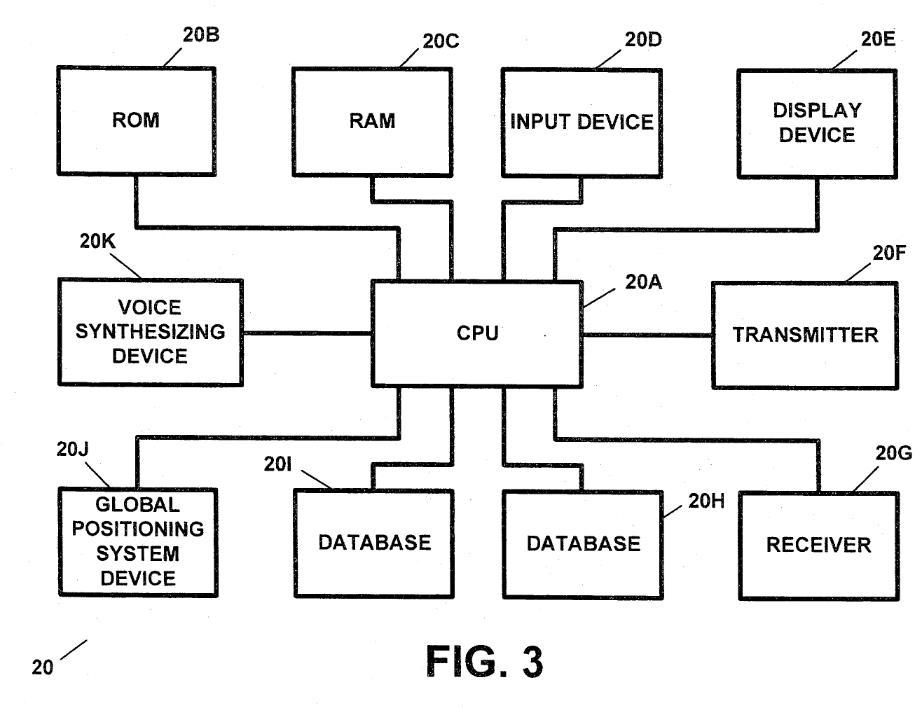

FIG. 3 illustrates the vehicle computer 20 of FIG. 2, in block diagram form. The vehicle computer 20 can be any computer, computer system, and/or any suitably equipped communication device, having at least the components and peripheral devices described herein, which can be adapted for performing the remote control function and processing routines and functionality described herein as being performed by the vehicle computer 20 and/or by the apparatus 100 of the present invention.

With reference to FIG. 3, the vehicle computer 20, in the preferred embodiment, is utilized to perform any and/or all of the remote control functions and processing routines described herein and for communicating with any of central processing computer(s) 30 and/or any of the herein-described traffic control device(s) 40.

In the preferred embodiment, the vehicle computer 20 includes a central processing unit or CPU 20A, which in the preferred embodiment, is a microprocessor. The CPU 20A, depending upon the application, may also be a microcomputer, a minicomputer, a macro-computer, and/or a mainframe computer. The CPU 20A, in the preferred embodiment, performs all of the remote control functions and processing functions and other control functions needed for controlling the operation of the traffic control devices 40 and the vehicle computer 20 along with any peripheral devices associated therewith.

The vehicle computer 20 also includes a read only memory device(s) 20B (ROM) and a random access memory device(s) 20C (RAM), each of which is connected to the CPU 20A, a user input device 20D, for entering data and/or commands into the vehicle computer 20, and which can include any one or more of a keyboard, a scanner, a user pointing device, such as, for example, a mouse, and/or a touch pad, which input device(s) are also connected to the CPU 20A. The user input device 20D can also include a microphone for inputting voice commands, present location information, and/or destination information, into the vehicle computer 20.

The vehicle computer 20 can also include a display device 20E for displaying data and/or information to a vehicle operator or occupant.

The vehicle computer 20 can also include a transmitter(s) 20F, for transmitting signals and/or data and/or information to any one or more of the central processing computer(s) 30, and/or to any of the herein-described traffic control device(s) 40, which are described as being utilized with the apparatus 100. The transmitter 20F can also transmit control signals, control codes, and/or command codes, to the central processing computer 30 and/or to the traffic control devices 40, which are utilized in conjunction with the present invention. The vehicle computer 20 can also include a receiver 20G, for receiving signals and/or data and/or information from the central processing computer(s) 30, and/or from any of the traffic control device(s) 40.

The vehicle computer 20 can also include a database(s) 20H which can contain any and/or all of the data and/or information which may be needed and/or desired in performing the remote control functions and processing routines described herein, such as, but not limited to, those routines for providing for the remote control of the operating of any of the traffic control devices 40 described herein and/or for determining and providing any of the herein-described information, directions, and/or instructions, to the vehicle operator or occupant.

The database 20H can contain the identification information and location information of or for the various traffic control devices 40 utilized in conjunction with the present invention. The database 20H can contain also contain IP address information or access code(s) for the traffic control devices 40 and/or the IP address information or access code(s) of central processing computers 30 which provide or facilitate the remote control of the traffic control devices 40 and/or the IP address of central processing computers via which remote control of the respective traffic control devices 40 can be controlled.

The database 20H can also contain operating schedules for the respective functions of the respective traffic control devices, such as, for example, red light “on” and “off” times, green light “on” and “off” times for the traffic control device 40. The database 20H can also contain information regarding whether and to what extent any of the traffic control device functions or operations can be controlled and the required control code(s) or command code(s) which may be associated with the respective control function.

The database 20H can also contain data and/or information regarding the any control functions, control command codes, and the various control commands which are associated with and/or which my be utilized in conjunction with each of the respective traffic control devices 40. The database 20H can also contain software programs and algorithms for enabling the vehicle computer 20 to perform the remote control functions for the various traffic control devices which are utilized in conjunction with the present invention.

For example, the database 20H can include identification information and location information for a traffic control device 40 such as a traffic light controlling traffic at a four way intersection, the IP address or access code for enabling the vehicle computer 20 to communication with the traffic control device or the IP address or access code(s) for the central processing computer 30 via which a vehicle computer 20 can provide control over the traffic control device 40.

The database 20H can also, for example, store information regarding red light “on” and “off” times, green light “on” and “off” times for the traffic control device 40 as well as provide information regarding whether the respective red light “on” and “off” operations and/or green light “on” and “off” operations can be controlled by the vehicle computer 20 or the central processing computer 30 and any control data and/or information, control code(s), command code(s) which are associated with the control function which can be performed on the traffic control device 40.

The database 20H can also include map information in digital form or digitized form, with which the information regarding the various traffic control devices can be correlated.

The database 20H can also contain map information in digital form or digitized form, geographical map information, area map information, road or street information, road or street location information, road or street name information, road or street location information, road or street position information, road or street coordinate information, road or street name, road or street intersection information, including road(s) or street(s) intersecting with same, the location of the respective intersection(s), the position of the respective intersection(s), the coordinates of the respective intersection(s), allowed direction of travel (i.e. one-way street, two-way street), allowed speed of travel on a respective road or street, posted speed limit on a respective road or street, length of road or street, distance between intersections on a road or street, traffic control devices (i.e. traffic lights, stop signs, etc.) on a road, street, or intersection, and any other information which may be needed and/or desired in facilitating the operation of the apparatus and method of the present invention, for each road or street or other travel thoroughfare, associated with an area for which a map or map information can or may be utilized.

The database 20H can also contain, for each of the herein-described roads, streets, intersections, traffic control devices, traffic control signals, traffic signs, etc., positional information or location information which can include X and Y coordinate data and/or information.

The database 20H can also contain, for each road or street, data and/or information regarding allowed turns (i.e. left or right turn allowed, right turn only allowed, left turn only allowed, no turns allowed, etc.), road or street direction of travel (i.e. north, northeast, east, southeast, south, southwest, west, northwest, etc.), traffic directions (i.e. one-way, two-way, etc.), and any other information regarding a characteristic of a road or street such as, for example, a through road or street or a dead end road or street.

The database 20H can also contain identification information and/or identifiers for each road, street, intersection, or any landmarks in a map area (i.e. hospital, school, park, bridge, museum, etc.).

The database 20H can also contain IP address information for each central processing computer 30 which can service a geographical area, IP address information for each traffic control device 40 in a geographical area, and/or another related information.

The database 20H can also contain pre-stored travel routes, pre-stored alternate travel routes, and any information relating thereto for any commonly known or popular travel routes, for any routes leading to a commonly known or popular travel destination, and/or any routes leading from a commonly known or popular travel origin. The database 20H can also contain, for any pre-stored routes, the travel distances of the routes, average speed along the route, number of turns involved along the route, and any other information regarding the route.

The database 20H can also contain information regarding the on times and off times of traffic control devices 40, green light on times, red light on times, frequency of green light to red light transition, etc., for each respective traffic control device 40.

The database 20H can also contain information regarding the observed average speed of travel of vehicles on a road or street and/or through an intersection, the average speed of travel of vehicles on a road or street and/or through an intersection, the average time a vehicle stops at a traffic control device (i.e. traffic light, etc.) or traffic signal (i.e. stop sign, yield sign, or other traffic sign(s)), the observed average speed of travel of vehicles on a road or street and/or in the vicinity of a traffic control device or traffic sign, the average speed of travel of vehicles on a road or street in the vicinity of a traffic control device or traffic sign, the average speed of travel of vehicles on a road or street in the absence of a traffic control device or traffic sign, and/or any other data and/or information regarding known, observed, or recorded, characteristics regarding travel in a geographic area.

The database 20H can also include the distance of travel along a road, a street, or a segment thereof, between intersections, the distance of travel through an intersection or a segment of a road or street in the vicinity of a traffic control device, the average speed of travel along a road, a street, or a segment of same, the average speed of travel through an intersection or a segment of a road or street in the vicinity of a traffic control device, the observed and/or estimated average speed of travel through an intersection or a segment of a road or street in the vicinity of a traffic control device, the average time of travel through an intersection or a segment of a road or street in the vicinity of a traffic control device, and the observed and/or estimated time of travel through an intersection or a segment of a road or street in the vicinity of a traffic control device.

The database 20H can also contain information regarding IP addresses for any of the central processing computers 30 and for any of the traffic control devices 40 which can be utilized in conjunction with the present invention. The database 20H can also contain any other information (i.e. use characteristics, etc.), not previously described herein, for and/or regarding any of the roads, streets, intersections, and/or traffic control devices, traffic signals, etc., described herein.

The database 20H can also contain data and/or information regarding pre-determined routes to a destination from a given location, pre-determined fastest routes, pre-determined lowest congestion routes, pre-determined routes which involve the minimum number of turns in order to reach a destination from a given location, and/or any other related data and/or information.

The database 20H can also contain software programs and/or processing algorithms and/or routines for data and/or information processing for determining routes to a destination from a given location, for determining fastest routes, for determining lowest congestion routes, for determining routes which involve the minimum number of turns in order to reach a destination from a given location, and/or for determining any other related data and/or information.

The database 20H can also contain any other information described herein as being stored in and/or utilized by any of the respective central processing computers 30 and/or traffic control devices 40 which are utilized in conjunction with the apparatus and method of the present invention.

The data and/or information which is stored in the database 20H can be resident therein and/or can be obtained from, or loaded from, a compact disc (CD), a digital versatile disc (DVD), a magnetic tape, or any other storage medium. The information stored in the database 20H can also be downloaded from the central processing computer(s) 30 and/or from any of the traffic control device(s) 40.

With reference once again to FIG. 3, the vehicle computer 20 also includes a global positioning system (GPS) device 20I which can be utilized for determining the position or location of the vehicle. The vehicle computer 20 can also include an output device 20J, such as a printer, a modem, a fax/modem, or other output device, for providing data and/or information to the operator or occupant of the vehicle.

With reference once again to FIG. 3, the vehicle computer 20 can also include a voice synthesizing device system 20K which can include at least a voice synthesizing device and associated speaker for providing audio voice information, directions, and/or instructions, to a vehicle operator or occupant(s). In this manner, voice synthesized driving information, directions, and/or instructions, can be provided to the operator or occupant of the vehicle.

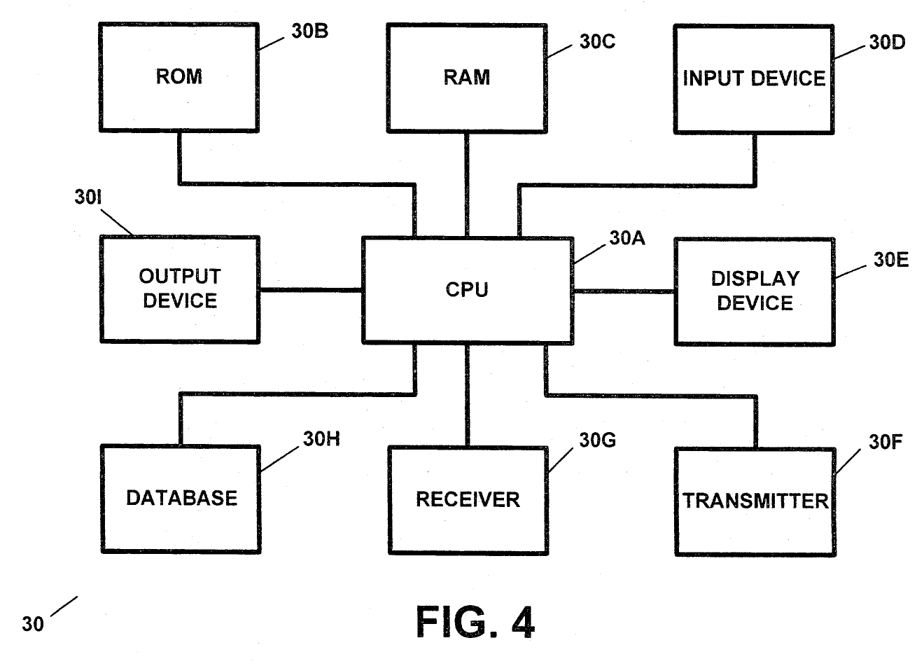

FIG. 4 illustrates the central processing computer 30 of FIG. 2, in block diagram form. The central processing computer 30 can be any computer, computer system, network computer, server computer, and/or any suitably equipped communication device, having at least the components and peripheral devices described herein, which can be adapted for performing the remote control functions and the processing routines and functionality described herein as being performed by the central processing computer 30 and/or the apparatus 100 of the present invention.

The central processing computer 30 can be utilized in order to provide any and/or all of the remote control functionality and processing routines and functionality described herein for any number of vehicle computers 20.

The central processing computer 30 can also be utilized in order to provide any and/or all of the remote control functions and processing routines and functionality described herein for any number of traffic control devices 40.

With reference to FIG. 4, the central processing computer 30, in the preferred embodiment, is utilized to perform any and/or all of the remote control functions and the processing routines described herein and for communicating with any of the vehicle computers 20, with any of the herein-described traffic control device(s) 40, and with any of the other central processing computers 30, which may be utilized.

In the preferred embodiment, the central processing computer 30 includes a central processing unit or CPU 30A, which in the preferred embodiment, is a microprocessor. The CPU 30A, depending upon the application, may also be a microcomputer, a minicomputer, a macro-computer, and/or a mainframe computer. The CPU 30A, in the preferred embodiment, performs all of the processing functions and control functions needed for controlling the operation of the central processing computer 30 and any peripheral devices associated therewith.

The central processing computer 30 also includes a read only memory device(s) 30B (ROM) and a random access memory device(s) 30C (RAM), each of which is connected to the CPU 30A, a user input device 30D, for entering data and/or commands into the central processing computer 30, and which includes any one or more of a keyboard, a scanner, a user pointing device, such as, for example, a mouse, and/or a touch pad, which input device(s) are also connected to the CPU 30A. The user input device 30D can also include a microphone for inputting voice commands into the central processing computer 30. The central processing computer 30 can also include a display device 30E for displaying data and/or information to an operator of the central processing computer 30.

The central processing computer 30 can also include a transmitter(s) 30F, for transmitting signals and/or data and/or information to any one or more of the vehicle computers 20, to any of the herein-described traffic control device(s) 40, and/or to any other central processing computer(s) 30, which are described as being utilized with the apparatus 100. The transmitter 30F can also transmit control signals, control codes, and/or command codes, to the traffic control devices 40 which are utilized in conjunction with the present invention. The processing computer 30 can also include a receiver 30G, for receiving signals and/or data and/or information from any of the vehicle computers 20, from any of the traffic control device(s) 40, and/or from any of the other central processing computer(s) 30, which are described as being utilized with the apparatus 100.

The central processing computer 30 can also include a database(s) 30H which can contain any and/or all of the data and/or information which may be needed and/or desired in performing the remote control functions and the processing routines described herein as being performed by the central processing computer 30, such as, but not limited to, routines for processing control signals and/or control data which is transmitted to the central processing computer 30 from the vehicle computer 20, routines for generating and transmitting control signals and/or control data to a respective traffic control device or traffic control devices, routines for controlling the operation of the respective traffic control devices, routines for determining and providing any of the herein-described information, directions, and/or instructions, to any of the herein-described vehicle computers 20, and/or routines for facilitating communications and/or interfacing with any of the vehicles computers 20, with any of the traffic control devices, and/or with any other central processing computers 30 which may be utilized.

The database 30H can contain any and/or all of the data and/or information, including programs and algorithms, described above as being stored in the database 20H of the vehicle computer 20. The database 30H can contain the identification information and location information of or for the various traffic control devices 40 utilized in conjunction with the present invention.

The database 30H can contain also contain IP address information or access code(s) for the traffic control devices 40 and/or the IP address information or access code(s) of any other central processing computers 30 which can provide or facilitate the remote control of the traffic control devices 40 and/or the IP address of central processing computers via which remote control of the respective traffic control devices 40 can be controlled.

The database 30H can also contain operating schedules for the respective functions of the respective traffic control devices 40, such as, for example, red light “on” and “off” times, green light “on” and “off” times for the traffic control device 40. The database 30H can also contain information regarding whether and to what extent any of the traffic control device functions or operations can be controlled and the required control code(s) or command code(s) which may be associated with the respective control function.

The database 30H can also contain data and/or information regarding the any control functions, control command codes, and the various control commands which are associated with and/or which my be utilized in conjunction with each of the respective traffic control devices 40. The database 30H can also contain software programs and algorithms for facilitating the effectuating or the herein-described remote control functions described as being performed by the vehicle computer 20 for any of the various traffic control devices which are utilized in conjunction with the present invention.

For example, and as described above in connection with the description of the database 20H of the vehicle computer 20, the database 30H can contain identification information and location information for a traffic control device 40 such as a traffic light controlling traffic at a four way intersection, the IP address or access code for enabling the vehicle computer 20 to communication with the traffic control device or the IP address or access code(s) for any other central processing computer 30 via which a vehicle computer 20 can provide control over the traffic control device 40.

The database 30H can also, for example, store information regarding red light “on” and “off” times, green light “on” and “off” times for the traffic control device 40 as well as provide information regarding whether the respective red light “on” and “off” operations and/or green light “on” and “off” operations can be controlled by the vehicle computer 20 or the central processing computer 30 and any control data and/or information, control code(s), command code(s) which are associated with the control function which can be performed on the traffic control device 40.

The database 30H can also include map information in digital form or digitized form, with which the information regarding the various traffic control devices can be correlated.

The database 30H can also contain map information in digital form or digitized form, geographical map information, area map information, road or street information, road or street location information, road or street name information, road or street location information, road or street position information, road or street coordinate information, road or street name, road or street intersection information including road(s) or street(s) intersecting with same, the location of the respective intersection(s), the position of the respective intersection(s), the coordinates of the respective intersection(s), allowed direction of travel (i.e. one-way street, two-way street), allowed speed of travel on a respective road or street, posted speed limit on a respective road or street, length of road or street, distance between intersections on a road or street, traffic control devices (i.e. traffic lights, stop signs, etc.) on a road, street, or intersection, and any other information which may be needed and/or desired in facilitating the operation of the apparatus and method of the present invention, for each road or street or other travel thoroughfare, associated with an area or areas for which a map or map information can or may be utilized, and/or for any and/or all areas which are being serviced by the central processing computer 30.

The database 30H can also contain for each of the herein-described roads, streets, intersections, traffic control devices, traffic control signals, traffic signs, etc, positional information or location information which can include X and Y coordinate data and/or information.

The database 30H can also contain, for each road or street, data and/or information regarding allowed turns (i.e. left or right turn allowed, right turn only allowed, left turn only allowed, no turns allowed, etc.), road or street direction of travel (i.e. north, northeast, east, southeast, south, southwest, west, northwest, etc.), traffic directions (i.e. one-way, two-way, etc.), and any other information regarding a characteristic of a road or street such as, for example, a through road or street or a dead end road or street.

The database 30H can also contain identification information and/or identifiers for each road, street, intersection, or any landmarks in the map area (i.e. hospital, school, park, bridge, museum, etc.) in the area or areas serviced by the central processing computer 30.

The database 30H can also contain IP address information for each traffic control device(s) 40 in a geographical area, and for any other central processing computers 30 which are or which may be utilized, and/or any another related information.

The database 30H can also contain pre-stored travel routes, pre-stored alternate travel routes, and any information relating thereto for any commonly known or popular travel routes, for any routes leading to a commonly known or popular travel destination, and/or any routes leading from a commonly known or popular travel origin. The database 30H can also include, for any pre-stored routes, the travel distances of the routes, the average speed along the route, the number of turns involved along the route, and any other information regarding the route.

The database 30H can also contain information regarding the on times and off times of traffic control devices, green light on times, red light on times, frequency of green light to red light transition, etc., for each respective traffic control device or traffic light.

The database 30H can also contain information regarding the observed average speed of travel of vehicles on a road or street and/or through an intersection, the average speed of travel of vehicles on a road or street and/or through an intersection, the average time a vehicle stops at a traffic control device (i.e. traffic light, etc.) or traffic signal (i.e. stop sign, yield sign, or other traffic sign(s)), the observed average speed of travel of vehicles on a road or street and/or in the vicinity of a traffic control device or traffic sign, the average speed of travel of vehicles on a road or street in the vicinity of a traffic control device or traffic sign, the average speed of travel of vehicles on a road or street in the absence of a traffic control device or traffic sign, and/or any other data and/or information regarding known, observed, or recorded, characteristics regarding travel in a geographic area.

The database 30H can also include the distance of travel along a road, a street, or a segment thereof, between intersections, the distance of travel through an intersection or a segment of a road or street in the vicinity of a traffic control device, the average speed of travel along a road, a street, or a segment of same, the average speed of travel through an intersection or a segment of a road or street in the vicinity of a traffic control device, the observed and/or estimated average speed of travel through an intersection or a segment of a road or street in the vicinity of a traffic control device, the average time of travel through an intersection or a segment of a road or street in the vicinity of a traffic control device, and the observed and/or estimated time of travel through an intersection or a segment of a road or street in the vicinity of a traffic control device.

The database 30H can also contain information regarding IP addresses for any of the vehicle computers 20, if utilized, for any of the traffic control devices 40 which are utilized, and for any of the other central processing computers 30 which may be utilized in conjunction with the present invention. The database 30H can also contain information (i.e. use characteristics, etc.), not previously described herein, for and/or regarding any of the roads, streets, intersections and/or traffic control devices, traffic signals, etc., which are described herein.

The database 30H can also contain data and/or information regarding pre-determined routes to a destination from a given location, pre-determined fastest routes, pre-determined lowest congestion routes, pre-determined routes which involve the minimum number of turns in order to reach a destination from a given location, and/or any other related data and/or information.

The database 30H can also contain software programs and/or processing algorithms and/or routines for data and/or information processing for determining routes to a destination from a given location, for determining fastest routes, for determining lowest congestion routes, for determining routes which involve the minimum number of turns in order to reach a destination from a given location, and/or for determining any other related data and/or information.

The database 30H can also contain any of the herein-described data and/or information for any number of vehicle computers 20 and for any number of traffic control devices 40 in order to provide the functionality for same. The database 30H can also contain information regarding vehicle owners or operators who may subscribe to the services provided by the apparatus 100 or the central processing computer 30.

The database 30H can also contain any other data and/or information described herein as being stored in and/or utilized by any of the respective vehicle computers 20 and/or the traffic control devices 40 which are utilized in conjunction with the apparatus and method of the present invention.

The data and/or information which is stored in the database 30H can be resident therein and/or can be obtained from, or loaded from, any number of compact discs (CDs), digital versatile discs (DVDs), magnetic tapes, or any other storage mediums. The information stored in the database 30H can also be downloaded from other central processing computer(s) 30 and/or from any of the traffic control device(s) 40 described herein.

The central processing computer 30 can also include an output device 30I, such as a printer, a modem, a fax/modem, or other output device, for providing data and/or information to the operator of the central processing computer 30.

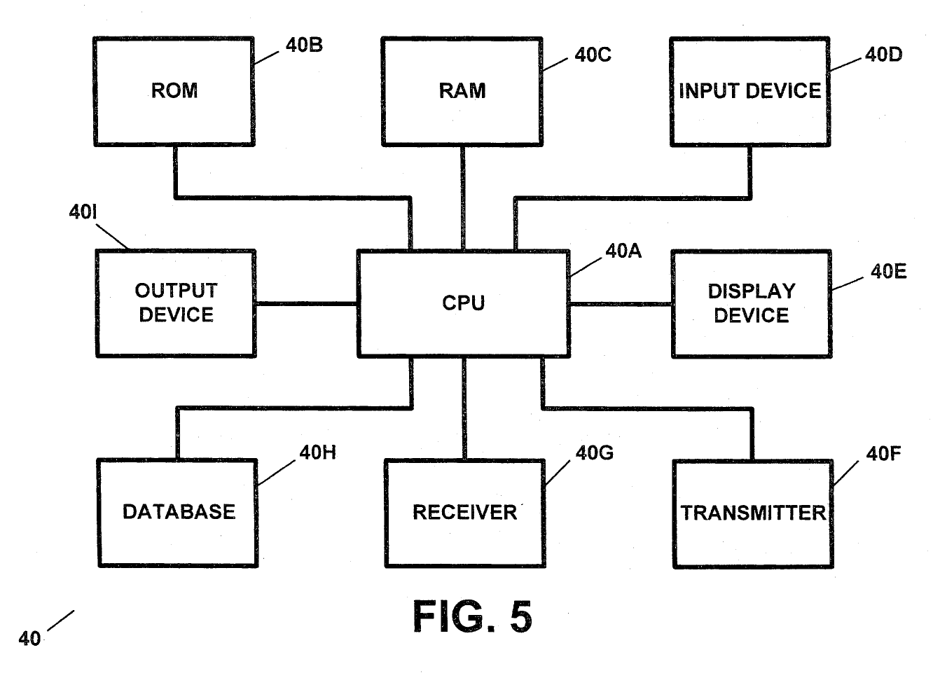

FIG. 5 illustrates the traffic control device 40 of FIG. 2, in block diagram form. The traffic control device 40 can be any traffic control device, traffic light, display device, message display device, or traffic sign capable of having a processing functionality. In addition to operating in a stand alone embodiment, the traffic control device 40, in the preferred embodiment, is also adapted to be controlled by, and/or to be controllable by, the vehicle computer 20 or by the central processing computer 30.

In the preferred embodiment, the traffic control device 40 is also adapted for processing any of the herein-described control signals, control codes, and/or command codes, which are provided by the vehicle computer 20 and/or by the central processing computer 30.

The traffic control device 40 can be, or can include, a computer, computer system, network computer, server computer, and/or any suitably equipped communication device, along with the functional devices of the respective traffic control device (i.e. traffic lights, message displays, blinking lights, etc.) and having any other components and peripheral devices described herein, which can be adapted for performing the processing routines and functionality described herein as being performed by the respective traffic control device 40 and/or the apparatus 100 of the present invention.

With reference to FIG. 5, the traffic control device 40, in the preferred embodiment, is utilized to perform any and/or all of the processing routines and traffic control functions described herein and for communicating with any of the vehicle computers 20, with any of the central processing computers 30, and/or with any of the other traffic control devices 40 which may be utilized with the present invention.

In the preferred embodiment, the traffic control device 40 includes a central processing unit or CPU 40A, which in the preferred embodiment, is a microprocessor. The CPU 40A, depending upon the application, may also be a microcomputer, a minicomputer, a macro-computer, and/or a mainframe computer.

The CPU 40A, in the preferred embodiment, performs all of the processing functions and control functions needed for controlling the operation of the traffic control device 40 and any peripheral devices associated therewith.

The traffic control device 40 also includes a read only memory device(s) 40B (ROM) and a random access memory device(s) 40C (RAM), each of which is connected to the CPU 40A, a user input device 40D, for entering data and/or commands into the traffic control device 40, and which can include any one or more of a keyboard, a scanner, a user pointing device, such as, for example, a mouse, and/or a touch pad, which input device(s) are also connected to the CPU 40A. The user input device 40D can also include a microphone for inputting voice commands into the traffic control device 40. The traffic control device 40 can also include a display device 40E for displaying data and/or information to an operator of the traffic control device 40.

The traffic control device 40 also includes the traffic control equipment 40F which is associated with the respective traffic control device 40. The traffic control equipment 40F is also connected to the CPU 40A. The traffic control equipment 40F can be a respective traffic light, a flashing or blinking light, a traffic message display device, a controllable traffic sign, or any other equipment which can be associated with, or utilized in conjunction with, the respective traffic control device 40. For example, if the traffic control device is a traffic light utilized on or along roads, streets, or intersections, the traffic control equipment 40F can be the actual traffic light device which is controlled or which can be controllable by the traffic control device 40.

The traffic control device 40 can also include a traffic speed sensor 40G. The traffic speed sensor 40G is also connected to the CPU 40A. The traffic speed sensor 40G can be any one or more of the well known electrical sensors, optical sensors, laser sensors, mechanical sensors, or pneumatic sensors, which can be utilized for determining the speed of travel of vehicles along a road or street or through an intersection.

The traffic speed sensor 40G can utilize radar signals or optical signals to determine the speed of vehicles. The traffic speed sensor 40G can also be any suitable device for counting the number of vehicles which travel past a pre-determined point during a pre-specified time interval, which information can be utilized to determine an average speed of traffic flow. The traffic speed sensor 40G can be a physically integrated component of the traffic control device 40 or can be located separate and apart from same.

The traffic control device 40 can also include a transmitter(s) 40H, for transmitting signals and/or data and/or information to any one or more of the vehicle computers 20, to the central processing computer(s) 30, and/or to any other traffic control device(s) 40.

The traffic control device 40 can also include a receiver 40I, for receiving signals and/or data and/or information from any of the vehicle computers 20, from the central processing computer(s) 30, and/or from any other traffic control device(s) 40. The receiver 40I can also receive any of the herein-described control signals, control codes, and/or command codes, for controlling the operation of the traffic control device 40 and, which are transmitted to the traffic control device 40 from any of the vehicle computers 20 and/or from the central processing computer(s) 30.

The traffic control device 40 can also include a database(s) 40J which can contain any and/or all of the data and/or information which may be needed and/or desired in performing the processing routines described herein as being performed by the traffic control device 40, such as, but not limited to, routines for controlling the operation of the traffic control device 40 and for controlling traffic control signal light activation, message generation and/or display, and routines for processing any of the herein-described control signals, control codes, and/or command codes, and performing the desired control functionality corresponding to the respective control signals, control codes, and/or command codes.

The database(s) 40J can also contain any data and/or information needed and/or desired for performing any of the other operations described herein as being performed by, or being capable of being performed by, the respective traffic control device 40.

The database(s) can also contain any data and/or information needed for processing any of the herein-described control signals, control codes, and/or command codes, as well as any programs or algorithms for processing same and for effecting the desired control function corresponding thereto.

The database 40J can also contain data and/or information regarding the operating times, on/off frequencies, on/off cycle times, for any of the respective traffic control equipment (i.e. “on” time and duration for a green light, “on” time and duration of a displayed traffic message, etc.), and/or any other pre-programmed and/or programmable operating characteristics of the respective traffic control device 40.

The database 40J can also contain data and/or information for facilitating communications and/or for interfacing with any of the vehicles computers 20, with any of the central processing computers 30, and/or with any of the other traffic control devices 40, which may be utilized.

The database 40J can also contain information regarding the observed and/or recorded average traffic speed or the speed of travel of vehicles on a road or street and/or through an intersection, the average speed of travel of vehicles on a road or street and/or through an intersection, the average time a vehicle stops at a traffic control device (i.e. traffic light, etc.) or traffic signal (i.e. stop sign, yield sign, or other traffic sign(s)), the observed average speed of travel of vehicles on a road or street and/or in the vicinity of a traffic control device or traffic sign, the average speed of travel of vehicles on a road or street in the vicinity of a traffic control device or traffic sign, the average speed of travel of vehicles on a road or street in the absence of a traffic control device or traffic sign, and/or any other data and/or information regarding known, observed, or recorded, characteristics regarding travel in a geographic area.

The database 40J can also contain information regarding IP addresses for any of the central processing computers 30 and/or for any other traffic control devices 40 which are utilized in conjunction with the present invention.

The database 40J can also contain any other data and/or information described herein as being stored in and/or utilized by the respective vehicle computers 20 and/or central processing computers 30 which are utilized in conjunction with the apparatus and method of the present invention.

The data and/or information which is stored in the database 40J can be resident therein and/or can be obtained from, or loaded from, any number of compact discs (CDs), digital versatile discs (DVDs), magnetic tapes, or any other storage mediums. The information stored in the database 40J can also be downloaded from any of the central processing computer(s) 30 and/or from any of the other traffic control device(s) 40 utilized in conjunction with the present invention.

The traffic control device 40 can also include an output device 40K such as a printer, a modem, a fax/modem, or other output device, for providing data and/or information to the operator of the traffic control device 40.

The apparatus and method of the present invention can be utilized in a number of preferred embodiments in order to provide remote control of traffic control devices and/or to provide driving information, directions, and/or instructions, to a vehicle operator or occupant.

In one preferred embodiment, the apparatus 100 can be utilized, and can operate, in a “stand alone” embodiment wherein the vehicle computer 20 can perform a remote control of a traffic control device 40 or traffic control devices 40. In this embodiment, the vehicle computer 20 can perform all of the processing routines and/or functionality which can be provided by the present invention.

In another preferred embodiment, the apparatus 100 can be utilized, and can operate, on an on-line environment, wherein the vehicle computer 20 can perform a remote control of a traffic control device 40 or traffic control devices 40 via the central processing computer 30.

In a “stand alone” embodiment, the vehicle computer 20 can utilize data and/or information which is stored in its database 20H and/or data and/or information which can be obtained from a traffic control device(s) 40. The vehicle computer 20 can also process information which can be stored on, or which can be obtained from, a compact disc (CD), a digital video disc (DVD), a magnetic or other tape, and/or any other storage media capable of being utilized by the vehicle computer 20. In this regard, no data and/or information is transmitted to or received from any of the herein-described central processing computer(s) 30.

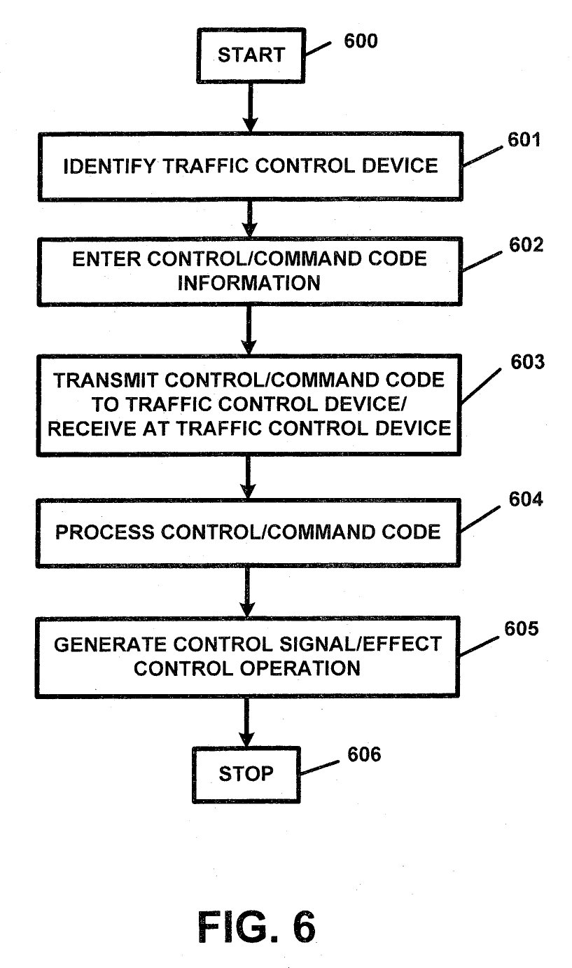

FIG. 6 illustrates a flow diagram of the operation of the apparatus 100 of the present invention in a vehicle computer 20 “stand alone” remote control embodiment. In the embodiment of FIG. 6, the operation of the apparatus 100 commences at step 600. At step 601, a traffic control device 40 along the vehicle's travel route, which is to be controlled, can be identified. The traffic control device can be identified by any one or more of a number of methods.

In a preferred embodiment, the vehicle computer 20 can identify the traffic control device 40 by ascertaining vehicle position by utilizing global positioning system (GPS) device 20I. By determining vehicle position and/or vehicle direction of travel, at step 601, the vehicle computer 20 can identify the traffic control device 40 which the vehicle is approaching.

In another embodiment, at step 601, the traffic control device 40 can be identified visually by the operator and/or occupant.

Thereafter, the traffic control device 40 can be identified by entering information regarding the traffic control device 40 into the vehicle computer 20 such as by directly entering any known identification information or identification code(s) corresponding to the traffic control device 40 and/or by selecting the traffic control device 40 from a menu of traffic control devices 40 which can be identified as being existent along the travel route.

At step 602, the vehicle operator or occupant can enter control code information and/or command code information into the vehicle computer 20 for controlling the operation of the identified traffic control device 40. For example, if during travel along a roadway, a traffic control device or traffic light is identified as being in a red light being “on” mode of operation, the vehicle operator or occupant can identify the traffic control device 40 and enter a control code and/or command code to remotely control the traffic control device 40 so as to turn the red light “off” and the green light “on”, thereby enabling the vehicle to continue traveling to its destination with minimum delay.

At step 603, a control signal, control code, and/or command code, corresponding to the control code or command code, can be transmitted from the vehicle computer 20 to, and received by, the traffic control device 40. At step 604, the traffic control device 40 can process the control signal, control code, and/or command code, received from the vehicle computer 20 and, at step 605, the traffic control device 40 can generate a control signal for effecting the desired operation of the traffic control device 40. At step 605, the traffic control device 40 can also effect the desired operation. For example, the traffic control device 40 can turn the red light “off” and turn a green light “on”. Thereafter, the operation of the apparatus can cease at step 606.

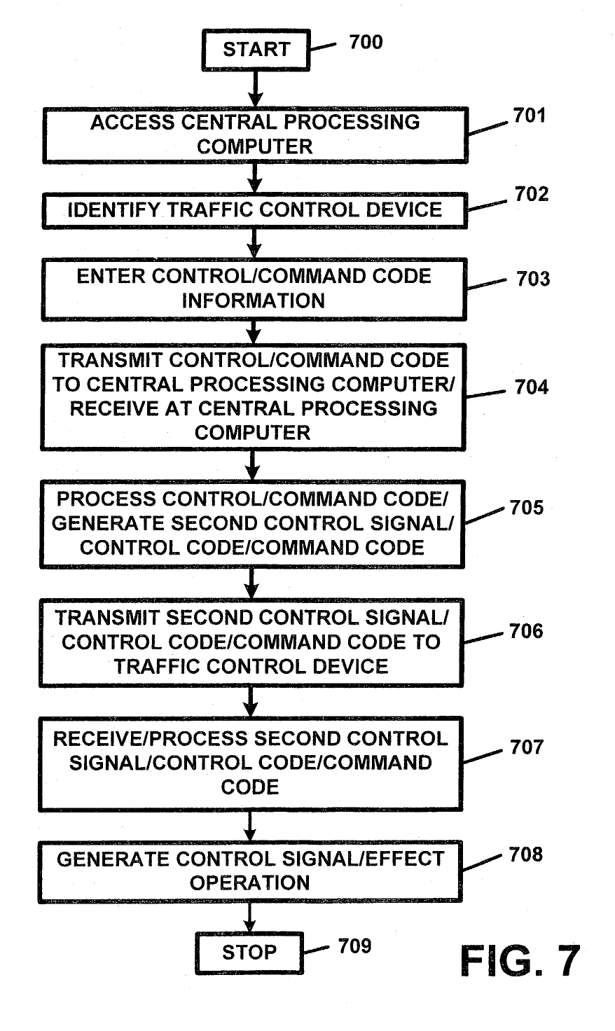

FIG. 7 illustrates a flow diagram of the operation of the apparatus 100 of the present invention in another preferred embodiment wherein the vehicle computer 20 provides remote control of the traffic control device 40 via the central processing computer 30.

In the embodiment of FIG. 7, the operation of the apparatus 100 commences at step 700. At step 701, the vehicle operator or occupant can access the central processing computer 30 with the vehicle computer 20. At step 702, the traffic control device 40, which is to be controlled, can be identified. At step 702, the vehicle's travel route can also be identified. As described above, the traffic control device 40 can be identified by any one or more of a number of methods.

In a preferred embodiment, the vehicle computer 20 can identify the traffic control device 40 by ascertaining vehicle position by utilizing global positioning system (GPS) device 20I. By determining vehicle position and/or vehicle direction of travel, at step 702, the vehicle computer 20 can identify the traffic control device 40 which the vehicle is approaching.

In another embodiment, the central processing computer 30 can receive vehicle position information from the vehicle computer 20 and can thereafter identify a traffic control device 40 which is being approached by vehicle, such as by utilizing any of the herein-described data and/or information which is stored in the database 30H. In another embodiment, at step 702, the traffic control device 40 can also be identified visually by the operator and/or occupant.

Thereafter, the traffic control device 40 can be identified by entering information regarding the traffic control device 40 into the vehicle computer 20 such as by directly entering any known identification information or identification code(s) corresponding to the traffic control device 40 and/or by selecting the traffic control device 40 from a menu of traffic control devices 40 which can be identified as being existent along the travel route.

At step 703, the vehicle operator or occupant can enter a control code information and/or command code into the vehicle computer 20 for controlling the operation of the identified traffic control device 40. For example, if during travel along a roadway, a traffic control device is identified as being in a red light being “on” mode of operation, the vehicle operator or occupant can identify the traffic control device 40 and enter a control code and/or command code, to remotely control the traffic control device 40 so as to turn the red light “off” and the green light “on” so as to enable the vehicle to continue traveling to its destination with minimum delay.

At step 704 a control signal, control code, and/or command code, corresponding to the control code or command code, can be transmitted from the vehicle computer 20 to, and received by, the central processing computer 30. At step 705, the central processing computer 30 can process the received control signal, control code, and/or command code, identify the traffic control device which is to be controlled, identify the operation or function to controlled, and generate a second control signal, control code, and/or command code. At step 706, the second control signal, control code, and/or command code, can be transmitted from the central processing computer 30 to the traffic control device 40.

At step 707, the traffic control device 40 can receive and process the second control signal, control code, and/or command code, which is received from the central processing computer 30. At step 708, the traffic control device 40 can generate a control signal for effecting the desired operation of the traffic control device 40. At step 708, the traffic control device can effect the desired operation. For example, the traffic control device 40 can turn the red light “off” and turn a green light “on”. Thereafter, the operation of the apparatus 100 can cease at step 709.

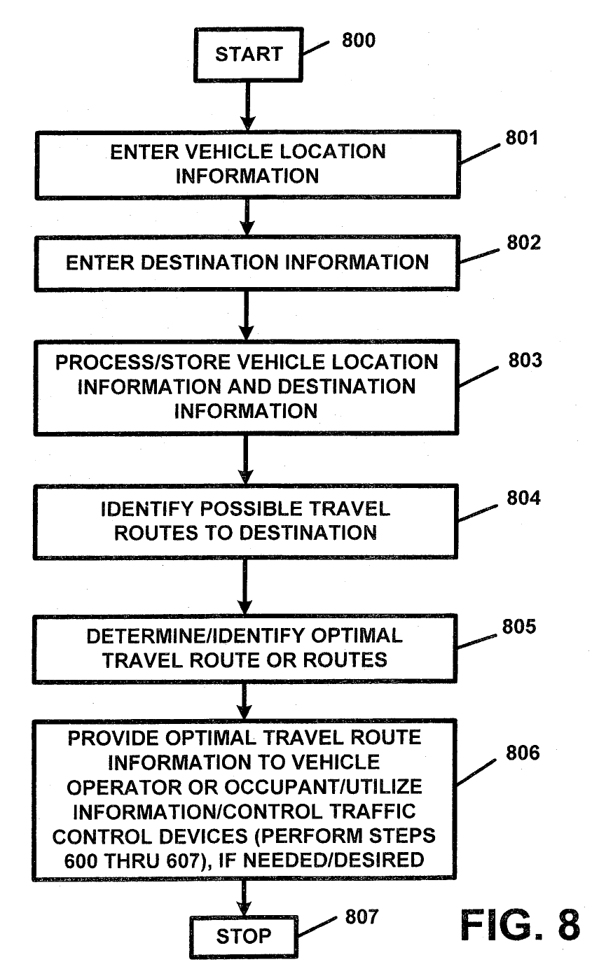

FIG. 8 illustrates another preferred embodiment wherein the apparatus 100 of the present invention can be utilized in order to provide driving information, directions, and/or instructions, for directing the vehicle operator or occupant from a present or known location to a pre-determined or pre-selected destination via an optimal travel route, and can also provide for the remote control of traffic control devices 40 along the travel route.

Typically, the term “optimal travel route” can mean the travel route having the shortest travel time. Depending upon the circumstances, however, the “optimal travel route”, can also be defined to refer to the travel route having the fewest or minimum number of turns along a travel route to a destination, the fewest or minimum number of traffic lights, traffic signs, or other traffic control devices, which are encountered along a travel route to a destination, the fewest or minimum number of travel encumbrances (i.e. road work, construction, accidents, bridges, tolls, etc.) which are encountered along a travel route to a destination, and/or any other criteria which can be pre-selected or dictated by the vehicle operator or occupant. In another embodiment, the embodiment of FIG. 8 can also be utilized with any travel route which may, but need not be, an optimal travel route.

The apparatus 100 and, in particular, the vehicle computer 20, can identify any number of optimal travel routes as it is recognized that oftentimes two or more travel routes may qualify as optimal routes.

With reference to FIG. 8, the operation of the apparatus 100 commences at step 800. At step 801, the vehicle operator or occupant can enter information regarding the present location of the vehicle into the vehicle computer 20. The vehicle location information can be entered manually, via the user input device 20D, and/or automatically, via the global positioning system device 20I. In an instance when present location information is entered via the user input device 20D, the location or position can be entered in the first instance by the vehicle operator or occupant or can be selected from a menu screen of locations or positions in the area of service.

In an instance when present location information is entered via the global positioning system device 20I, the vehicle operator or occupant can activate the global positioning system device 20I, such as via the user input device 20D, and the global positioning system device 20I can automatically determine and enter vehicle position or location information, which can thereafter be stored and processed by the vehicle computer 20.

At step 802, the vehicle operator or occupant can enter information regarding the desired destination into the user input device 20D. The destination information can be entered in the first instance by the vehicle operator or occupant or can be selected from a menu screen of destinations in the particular area of service.

At step 803, the vehicle computer 20 and, in particular, the CPU 20A, will process and store the present location or position information and the destination information.

At step 804, the vehicle computer 20 will identify all possible travel routes from a present location to the destination. At step 804, the vehicle computer 20 will identify all travel routes to the destination by taking into account the presence of one-way only streets, two-way streets, and/or other travel or traffic rules, in the geographic area of travel.

At step 804, the vehicle computer 20 can also determine the travel distance along each road or street, or segment thereof, for each leg of a travel route, for each of the identified possible travel routes. At step 804, the vehicle computer 20 can also identify intersections which exist along each of the possible travel routes. At step 804, the vehicle computer 20 can also identify the existence of traffic control devices, traffic lights, traffic signals, etc., which exist along a travel route, for each of the possible travel routes.

At step 805, the vehicle computer 20 can process the information regarding the possible travel routes and determine the optimal travel route or optimal travel routes.

In one embodiment of step 805, the vehicle computer 20 can determine the optimal travel route or routes by utilizing information stored in the database 20H which does not include the states of any of the various traffic control devices 40 which may exist in a geographic area. In this manner, for example, the optimal travel route or routes can be determined when the green light on and off times for a traffic light or traffic lights along possible travel routes are not known. In such instances, the travel times through intersections or segments of roads or streets having these traffic lights can be approximated and stored in the database 20H and/or can be defined to be an unknown variable.

In a similar manner, the travel times through intersections or segments of roads or streets having these traffic lights can be approximated and stored in the database 20H and/or can be defined to be an unknown variable.

In another embodiment, the states of any of the various traffic control devices 40 which may exist in a geographic area can be known and can be pre-stored in the database 20H. In this manner, for example, the optimal travel route or routes can be determined by utilizing information regarding the time or times when a traffic light turns green and the duration of the green light, for each traffic light along the possible travel routes.

At step 805, the vehicle computer 30 can determine the optimal travel route or routes by generating an equation representing the expected travel time along each of the possible travel routes. An example of such an equation for a route involving travel from a present location, along road 1, along road 2, through an intersection having traffic light 3, along road 4, through an intersection having traffic light 5, and along road 6 until arrival at the destination, can be as follows:

$$TravTime = \frac{Dist1}{Speed1} + \frac{Dist2}{Speed2} + TC3 + \frac{Dist4}{Speed4} + TC5 + \frac{Dist6}{Speed6}$$

Where:

TravTime=the expected travel time from the present location to the destination.

DistN=the distance of travel along the Nth road.

SpeedN=the average speed of travel of vehicles along the Nth road.

TCN=the average time of travel along a road, or through an intersection, having Nth traffic control device.

DistN/Speed N=the amount of time to travel along the Nth road

By assigning a number or variable to each road or street segment, to each intersection, and to each traffic control device, which is located in a geographic area, every possible travel route from any present location in the area to any destination in the area can be represented by an equation. In instances where a road or street, a segment of a road or of a street, an intersection, or a traffic control device, is not utilized along a travel route, the entry for that respective road or street, intersection, or traffic control device, would be zero (0) and, therefore, would be left out of the equation for that travel route.

At step 805, the vehicle computer 20 can determine the equations for each of the possible travel routes. In the case of determining a travel route or routes having minimum travel times, the above equation can be utilized. In a similar manner, where minimum travel distance may be the criteria for an optimal travel route or routes, a distance equation including distances along roads, streets, or segments thereof, and distances through intersections, can be utilized in a simple distance equation.

In another embodiment, the optimal travel route can be determined by identifying the travel route which involves the minimum number of turns along a travel route to a destination.

At step 805, the vehicle computer 20 will determine the optimal travel route or route. In the preferred embodiment, the optimal travel route or routes are selected based on the minimum expected travel time or times. In another embodiment, a non-optimal travel route can also be identified, if desired.

At step 805, the vehicle computer 20 will determine the expected travel time for each of the possible travel routes by computing the expected travel times for each possible travel route, such as by using the above-described equation.

In one embodiment, where no information regarding the on times or on duration for a green light(s) of a traffic signal(s) are known or stored, but where an estimated average travel time though an intersection or road segment having a traffic signal(s) is known, the vehicle computer 20 can utilize the estimated average travel time or times to calculate the estimated travel times for each of the possible travel routes.

In another embodiment, where green light on times and duration are known, the amount of time spent at an intersection or road section having the traffic light can be estimated by calculating the estimated time of arrival at the respective intersection or road section and determining whether the light would be green or the amount of time which would have to elapse until the light turns green. In this manner, the time to travel through the intersection can be estimated.

In another embodiment, where no information regarding the on times or on duration for a green light(s) is known or stored, and no estimated average travel time(s) through an intersection or road segment having a traffic signal(s) is available, the unknown information can be represented by an unknown variable. The vehicle computer 20 can then solve for the unknown variable(s) and the expected travel times by utilizing linear programming routines which are well known to those skilled in the art of linear programming and operations research.

At step 805, the vehicle computer 20 can identify the optimal travel route to the destination and compile the information regarding the travel directions and/or instructions regarding the optimal travel route. At step 805, the vehicle computer 20 can also generate a message containing the travel directions and/or instructions corresponding to the optimal travel route. In an embodiment where two optimal travel routes are requested or desired, the vehicle computer 20 can identify the two optimal travel routes to the destination and compile the above-described information regarding the two optimal travel routes.

It is important to note that, at step 805, the vehicle computer 20, in one embodiment, can determine and/or identify the optimal travel route independently of information regarding the operating characteristics (i.e. traffic light green light on time(s), green light on time schedule(s), and green light on time duration(s)). In another embodiment, the vehicle computer 20 can determine and/or identify the optimal travel route by utilizing information regarding the operating characteristics of the traffic control devices.

At step 806, the vehicle computer 20 can provide the message along with the travel directions and/or instructions corresponding to the optimal travel route, to the vehicle operator or occupant by any one or more of displaying the travel directions or instructions on the display device 20E, by outputting the travel directions or instructions on the output device 20J, and/or by providing audible travel directions or instructions via the voice synthesizing device system 20K.

Thereafter, at step 806, the vehicle operator can utilize the travel directions or instructions in traveling to the destination.

At any time during step 806, a traffic control device 40 can be identified which may need to be controlled. For example, if the vehicle is approaching a traffic control device 40 or traffic light which is operating in red light “on” mode, the traffic control device 40 can be controlled via the vehicle computer 20 so as to change the operating mode to a green light “on” mode so as to minimize to any travel delay. In this regard, at step 806, the vehicle operator or occupant can provide for the remote control of the traffic control device 40 or traffic control devices 40 during travel to the destination.

If a traffic control device 40 is identified for which a remote control operation is desired, the apparatus 100 of the present invention can perform the remote control processing operational steps 600 through 606 for each traffic control device 40 for which the exercise of control is desired. In this regard, Applicant incorporates by reference herein, and hereby reasserts, the description of the embodiment of FIG. 6 along with the operational processing steps 600 through 606 which correspond thereto.

Thereafter, the operation of the apparatus 100 will cease at step 807 upon the vehicle's arrival at the destination.

In another preferred embodiment, the vehicle computer 20 can be utilized in conjunction with the central processing computer(s) 30 and/or with any one or more of the traffic control devices 40 which are utilized in conjunction with the present invention in order to provide driving information, directions, and/or instructions, for directing the vehicle operator or occupant from a present or known location to a pre-determined or pre-selected destination via an optimal travel route, and can also provide for the remote control of traffic control devices 40 along the travel route.

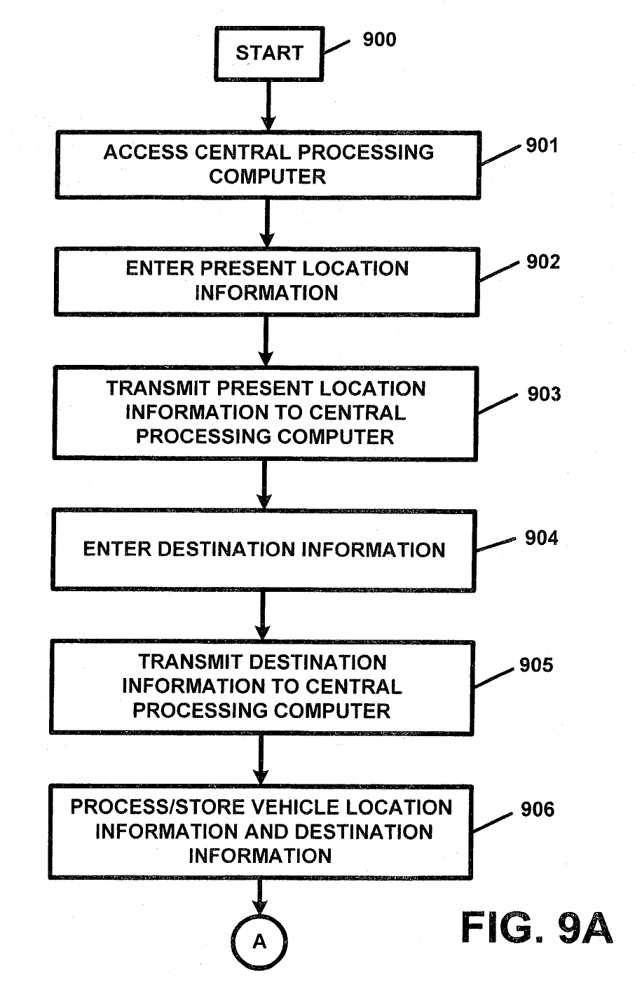

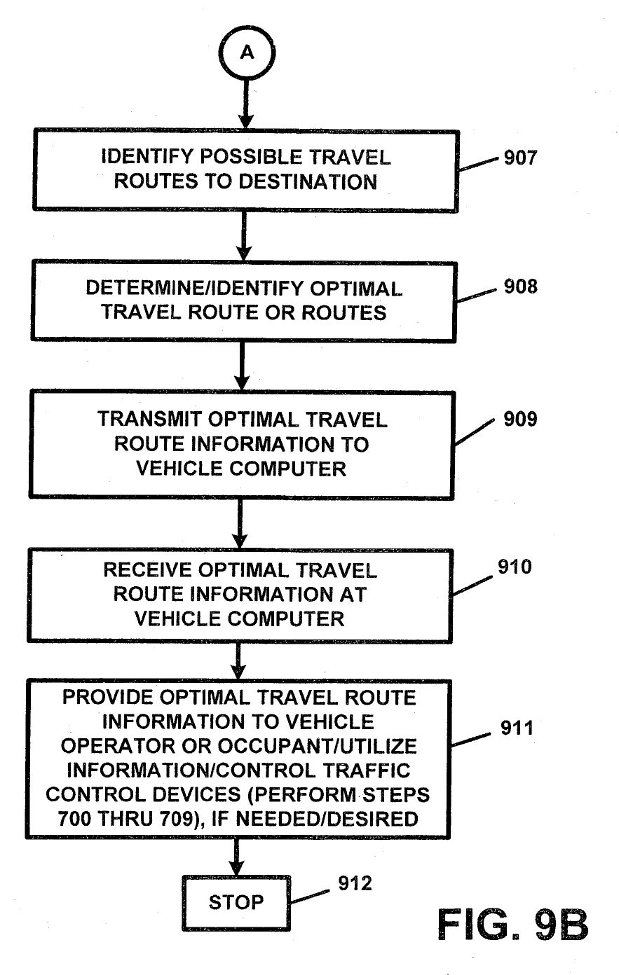

FIGS. 9A and 9B illustrate a flow diagram of the operation of the apparatus 100 of the present invention in an embodiment wherein the vehicle computer 20 is utilized in conjunction with at least one central processing computer 30. In the embodiment of FIGS. 9A and 9B, the apparatus 100 can be utilized in order to provide driving information, directions, and/or instructions, for directing the vehicle operator or occupant from a present or known location to a pre-determined or pre-selected destination via an optimal travel route.

As noted herein, the term “optimal travel route” can mean the travel route having the shortest travel time. As further noted herein, and depending upon the circumstances, the “optimal travel route”, can also be defined to refer to the travel route having the fewest or minimum number of turns along a travel route to a destination, the fewest or minimum number of traffic lights, traffic signs, or other traffic control devices, which are encountered along a travel route to a destination, the fewest or minimum number of travel encumbrances (i.e. road work, construction, accidents, bridges, tolls, etc.) which are encountered along a travel route to a destination, and/or any other criteria which can be pre-selected or dictated by the vehicle operator or occupant. In another embodiment, the travel route need not be, an optimal travel route.

The central processing computer 30 can identify the optimal travel route or any number of optimal travel routes as it is recognized that two or more travel routes may qualify as optimal routes. The central processing computer 30 can also identify a travel route which is not an optimal travel route.

With reference to FIGS. 9A and 9B, the operation of the apparatus 100 commences at step 900. At step 901, the vehicle operator or occupant can access the central processing computer 30 via the vehicle computer 20. At step 902, the vehicle operator or occupant can enter information regarding the present location of the vehicle into the vehicle computer 20.

The vehicle location information can be entered manually, via the user input device 20D, or automatically, via the global positioning system device 20I. In an instance when present location information is entered via the user input device 20D, the location or position can be entered in the first instance by the vehicle operator or occupant or can be selected from a menu screen of locations or positions in the area of service.

In an instance when present location information is entered via the global positioning system device 20I, the vehicle operator or occupant can activate the global positioning system device 20I, via the user input device 20D, and the global positioning system device 20I can automatically determine and enter vehicle position or location information which can thereafter be stored and processed by the vehicle computer 20.

At step 903, the information entered at step 902 can be transmitted to and received by the central processing computer 30.

At step 904, the vehicle operator or occupant can enter information regarding the desired destination into the input device 20D. The destination information can be entered in the first instance by the vehicle operator or occupant or can be selected from a menu screen of destinations in the particular area of service.

At step 905, the destination information entered at step 904 can be transmitted to and received by the central processing computer 30.

At step 906, the central processing computer 30 will process and store the present location or position information and the destination information.

At step 907, the central processing computer 30 will identify all possible travel routes from a present location to the destination. At step 907, the central processing computer 30 will identify all travel routes to the destination by taking into account the presence of one-way only streets, two-way streets, and/or other travel or traffic rules, in the geographic area of travel.

At step 907, the central processing computer 30 can also determine the travel distance along each road or street, or segment thereof, for each leg of a travel route, for each of the identified possible travel routes. At step 907, the central processing computer 30 can also identify intersections which exist along each of the possible travel routes. At step 907, the central processing computer 30 can also identify the existence of traffic control devices, traffic lights, traffic signals, etc., which exist along a travel route, for each of the possible travel routes.

At step 908, the central processing computer 30 can process the information regarding the possible travel routes and determine the optimal travel route or optimal travel routes. At any time during step 908, the central processing computer 30 can utilize any of the herein-described data and/or information which may be stored in the database 30H.

The central processing computer 30 can also obtain any other needed and/or desired information such as, for example, a traffic control device green light on-time and green light on duration, traffic speed through, or at, an intersection or road section in the vicinity of a traffic control device 40, by accessing and obtaining the information from any of the traffic control devices 40 which are identified as being on the identified possible travel route or travel routes.

The central processing computer(s) 30 and the traffic control devices 40 described as being utilized in conjunction with the apparatus 100 are capable of communication with each other in a bi-directional manner. In this regard, the central processing computer 30 can obtain any of the data and/or information, described herein as being utilized in any of the herein-described processing routines, from a respective traffic control device 40, in real-time and/or otherwise.

In one embodiment of step 908, the central processing computer 30 can determine the optimal travel route or routes by utilizing information stored in the database 30H which may or may not include information regarding the states of any of the various traffic control devices 40 which may exist in a geographic area. In another embodiment, the central processing computer 30 can obtain any missing and/or desired information directly from a respective traffic control device(s) 40 and/or from any other central processing computers 30 which may be utilized in conjunction with the apparatus 100.

In an embodiment where certain data and/or information is not available to the central processing computer 30 and/or the central processing computer 30 cannot obtain same from an external source, the optimal travel route or routes can be determined by utilizing estimated and/or stored estimations in a manner similar to that described above in conjunction with the embodiment of FIG. 8. For example, when the green light on and off times for a traffic light or traffic lights along possible travel routes are not known, the travel times through intersections or segments of roads or streets having these traffic lights can be approximated and stored in the database 30H and/or can be defined to be an unknown variable.

In a similar manner, the travel times through intersections or segments of roads or streets having these traffic lights can be approximated and stored in the database 30H and/or can be defined to be an unknown variable. In other instances, any unknown parameters or information can be defined to be unknown variables.

In another embodiment, the states of any of the various traffic control devices 40 which may exist in a geographic area can be known and can be pre-stored in the database 30H.

At step 908, the central processing computer 30 can determine the optimal travel route or routes by generating an equation representing the expected travel time along each of the possible travel routes. In one embodiment, the central processing computer 30 can utilize the equation:

$$TravTime = \frac{Dist1}{Speed1} + \frac{Dist2}{Speed2} + TC3 + \frac{Dist4}{Speed4} + TC5 + \frac{Dist6}{Speed6}$$

Where:

TravTime=the expected travel time from the present location to the destination.

DistN=the distance of travel along the Nth road.

SpeedN=the average speed of travel of vehicles along the Nth road.

TCN=the average time of travel along a road, or through an intersection, having Nth traffic control device.

DistN/Speed N=the amount of time to travel along the Nth Road

which was presented above in connection with the description of Step 805 of FIG. 8, along with the information and conventions described above as being utilized regarding the assigning of respective numbers or variables to respective road or street segments, to intersections, and to traffic control devices, which are located in a geographic area. In this manner, the central processing computer 30 can utilize and/or perform all of the processing routines and/or processing conventions described herein as being performed by the vehicle computer 20 in the embodiment of FIG. 8.

At step 908, the central processing computer 30 can determine the equations for each of the possible travel routes. In the case of determining a travel route or routes having minimum travel times, the equation presented above in the description of the embodiment of FIG. 8 can be utilized.

In a similar manner, wherein minimum travel distance may be the criteria for an optimal travel route or routes, a distance equation, including distances along roads, streets, or segments thereof, and distances through intersections, can be utilized in a simple distance equation.

In another embodiment, the optimal travel route can be determined by identifying the travel route which involves the minimum number of turns along a travel route to a destination.

At step 908, the central processing computer 30 can determine the optimal travel route. In the preferred embodiment, the optimal travel route can be selected based on the minimum expected travel time. In another embodiment, a non-optimal travel route can also be identified, if desired.

At step 908, the central processing computer 30 can determine the expected travel time for each of the possible travel routes by computing the expected travel times for each possible travel route such as by using the above-described equation.

In one embodiment, where no information regarding the on times or on duration for a green light(s) of a traffic signal(s) are known or stored, but where an estimated average travel time though an intersection or road segment having a traffic signal(s) is known, the central processing computer 30 can utilize the estimated average travel time or times to calculate the estimated travel times for each of the possible travel routes.

In another embodiment, where green light on times and duration are known, the amount of time spent at an intersection or road section having the traffic light can be estimated by calculating the estimated time of arrival at the respective intersection or road section and determining whether the light would be green or the amount of time which would have to elapse until the light turns green. In this manner, the time to travel through the intersection can be estimated.

In another embodiment, where no information regarding the on times or on duration for a green light(s) is known or stored, and no estimated average travel time(s) through an intersection or road segment having a traffic signal(s) is available, the unknown information can be represented by an unknown variable. The central processing computer 30 can then solve for the unknown variable(s) and the expected travel times by utilizing linear programming routines which are well known to those skilled in the art of linear programming and operations research.

At step 908, the central processing computer 30 can identify the optimal travel route to the destination and compile the information regarding the travel directions and/or instructions regarding the optimal travel route. At step 908, the central processing computer 30 can also generate a message containing the travel directions and/or instructions corresponding to the optimal travel route. In an embodiment where two optimal travel routes are requested or desired, the central processing computer 30 can identify the two optimal travel routes to the destination and compile the information regarding the optimal travel routes.

It is important to note that, at step 908, the central processing computer 30, in one embodiment, can determine and/or identify the optimal travel route independently of information regarding the operating characteristics (i.e. traffic light green light on time(s), green light on time schedule(s), and green light on time duration(s)). In another embodiment, the central processing computer 30 can determine and/or identify the optimal travel route by utilizing information regarding the operating characteristics of the traffic control devices.

At step 909, the central processing computer 30 can transmit the message containing the travel directions and/or instructions corresponding to the optimal travel route, to the vehicle computer 20. At step 910, the vehicle computer 20 will receive the message and optimal travel route information.

At step 911, the vehicle computer 20 will provide the information contained in the message along with the travel directions and/or instructions corresponding to the optimal travel route, to the vehicle operator or occupant by any one or more of displaying the travel directions or instructions on the display device 20E, by outputting the travel directions or instructions via the output device 20J, or by providing audible travel directions or instructions via the voice synthesizing device system 20K.

Thereafter, at step 911, the vehicle operator can utilize the travel directions or instructions in traveling to the destination.

At any time during step 911, a traffic control device 40 can be identified which may need to be controlled. For example, if the vehicle is approaching a traffic control device 40 or traffic light which is operating in red light “on” mode, the traffic control device 40 can be controlled by the vehicle computer 20 via the central processing computer 30 so as to change the operating mode to a green light “on” mode so as to minimize to any travel delay. In this regard, at step 911, the vehicle operator or occupant can provide for the remote control of the traffic control device 40 or traffic control devices 40 during travel to the destination via the central processing computer 30.

If a traffic control device 40 is identified for which a remote control operation is desired, the apparatus 100 of the present invention can perform the remote control processing operational steps 700 through 709 for each traffic control device 40 for which the exercise of control is desired. In this regard, Applicant incorporates by reference herein, and hereby reasserts, the description of the embodiment of FIG. 7 along with the operational processing steps 700 through 709 which correspond thereto.

Thereafter, the operation of the apparatus 100 will cease at step 912 upon the vehicle's arrival at the destination.

In any an/do all of the embodiments described herein the vehicle computer 20 can automatically detect the traffic control device 40 and its operational state (i.e. red light “on” or green light “on”, etc.). If the operating state is determined to be in a state which may require a change of operating state or which may dictate a control of same (i.e. red light “on”, etc.) the vehicle computer 20 can automatically control the traffic control device 40 by transmitting an appropriate control signal, control code, and/or command code to the traffic control device 40 and/or to the central processing computer 30. If the control signal, control code, and/or command code, is transmitted to the central processing computer 30, the central processing computer 30 can also automatically transmit the second control, control code, and/or command code, to the Traffic control device 40.

In another embodiment, the central processing computer 30 can automatically determine a vehicle position and an operating state of a traffic control device 40 which is being approached by the vehicle. The central processing computer 30 can then automatically control the traffic control device 40 so as to minimize any delay to the vehicle's travel.

In any and/or all of the embodiments described herein, the central processing computer 30 can, at any time, generate an information request message and transmit same to a traffic control device(s) in order to obtain operating characteristic information such as, green light on time or times, green light on time schedule or schedules, and/or green light on time duration or durations, from the respective device(s).

The respective traffic control device or devices 40 can receive the request, process same, and generate a response message. Thereafter, the response message can be transmitted from the traffic control device 40 to the central processing computer 30 and be received and utilized by the central processing computer 30 in performing any of the herein-described processing routines and/or functionality.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus for remotely controlling a traffic control device, comprising:
an input device for inputting at least one of a control code and a command code corresponding to a control operation to be performed on a traffic control device;
a processor for processing the at least one of a control code and a command code, wherein the processor generates a first control signal for performing a control operation on the traffic control device; and
a transmitter for transmitting the first control signal to the traffic control device, wherein the traffic control device receives the first control signal and generates a second control signal, wherein the second control signal effectuates the control operation.

2. The apparatus of claim 1, wherein identification information corresponding to the traffic control device is input via the input device.

3. The apparatus of claim 1, wherein the traffic control device is a traffic light, and further wherein the control operation turns a green light on.

4. The apparatus of claim 1, wherein the traffic control device is a traffic light, and further wherein the control operation turns a red light off.

5. The apparatus of claim 1, wherein the traffic control device is a traffic light, and further wherein the control operation turns a green light off.

6. The apparatus of claim 1, wherein the traffic control device is a traffic light, and further wherein the control operation turns a red light on.

7. The apparatus claim 1, further comprising:
a database for storing information regarding a travel area, wherein the information includes at least one of road information, street information, intersection information, and traffic control device information; and
wherein the processor processes a request for information regarding an optimal travel route from a present location of a vehicle to a destination, wherein the processor processes the request by utilizing the information stored in the database, and further wherein the processor identifies at least two possible travel routes to the destination, and further wherein the processor identifies an optimal travel route to the destination, wherein the processor generates a message containing travel directions or instructions corresponding to the optimal travel route; and
an output device for outputting information contained in the message.

8. The apparatus of claim 1, wherein the input device includes at least one of a keyboard, a mouse, a user pointing device, and a microphone.

9. The apparatus of claim 7, wherein vehicle present location information and destination information is input via the input device.

10. The apparatus of claim 1, further comprising:
a global positioning device for determining the vehicle present location information.

11. The apparatus of claim 1, further comprising:
an input device for inputting at least one of a command, vehicle present location information, and destination information; and
a global positioning device for determining vehicle present location information.

12. The apparatus of claim 1, further comprising:
a display device for displaying information to at least one of a vehicle operator or occupant.

13. The apparatus of claim 7, wherein a display device displays information contained in the message to at least one of the vehicle operator and occupant.

14. The apparatus of claim 7, wherein the output device is at least one of a printer, a display device, a voice synthesizer device, and a speaker.

15. The apparatus of claim 7, further comprising:
a voice synthesizer device for generating voice information corresponding to the information contained in the message, wherein the voice synthesizer device further comprises:
a speaker for providing the generated voice information to a least one of the vehicle operator and occupant.

16. The apparatus of claim 7, wherein the apparatus provides travel information for at least one of an urban area, a suburban area, and a rural area.

17. The apparatus of claim 7, wherein the optimal travel route involves the minimum travel time to the destination.

18. The apparatus of claim 7, wherein the optimal travel route involves the minimum travel distance to a destination.

19. The apparatus of claim 7, wherein the optimal travel route involves the minimum number of turns along a travel route to a destination.

20. The apparatus of claim 1, wherein the input device includes a microphone for receiving voice information regarding at least one of a control code, a command code, command, vehicle present location information, and destination information.

21. The apparatus of claim 7, wherein the processor identifies the optimal travel route independently of information regarding the operating characteristics of traffic control devices located along the at least two possible travel routes to the destination.

22. The apparatus of claim 1, wherein the traffic control device includes at least one traffic light, and further wherein operating characteristics of the traffic control device includes at least one of green light on time, green light on time schedule, and green light on time duration.

23. The apparatus of claim 7, wherein the processor identifies the optimal travel route by utilizing information regarding the operating characteristics of traffic control devices located along the at least two possible travel routes to the destination.

24. The apparatus of claim 23, wherein the traffic control device includes at least one traffic light, and further wherein the operating characteristics of the traffic control device includes at least one of green light on time, green light on time schedule, and green light on time duration.

25. The apparatus of claim 7, wherein the database contains at least one of map information, digitized map information, geographical map information, area map information, road information, street information, road location information, street location information, road position information, street position information, intersection information, intersection location, intersection position information, direction of travel information, allowed speed of travel information, allowed turning information, length of a road or street, distance between intersections on a road or street, traffic control devices on a road, street, or intersection, pre-stored travel route information, pre-stored alternate travel route information, pre-stored route travel distance information, average speed of travel information, information regarding the on times and off times of traffic control devices, observed average speed of travel of vehicles on a road, street, or intersection, average vehicle stop time at a traffic control device, distance of travel along a road, a street, or a segment thereof, between intersections, the distance of travel through an intersection, the distance of travel along a segment of a road or street in the vicinity of a traffic control device, and observed or estimated average speed of travel.

26. The apparatus of claim 7, wherein the information stored in the database can be at least one of resident in the database and obtained from at least one of a compact disc (CD), a digital versatile disc (DVD), a magnetic tape, and a storage medium.

27. The apparatus of claim 1, further comprising:
database for storing information regarding at least one traffic control device, identification information for at least one traffic control device, information for processing the at least one of a control code and a command code, and information for remotely controlling the traffic control device.

28. The apparatus of claim 1, further comprising:
a transmitter for transmitting vehicle present location information and destination information to a central processing computer; and
a receiver for receiving a message containing travel directions or instructions corresponding to an optimal travel route to a destination from the central processing computer.

29. The apparatus of claim 28, wherein at least a portion of the information stored in the database is received by the receiver, wherein the information is transmitted to the receiver from the central processing computer.

30. The apparatus of claim 1, wherein the apparatus operates in a network environment.

31. The apparatus of claim 1, wherein the apparatus operates at least one of on and over at least one of the Internet and the World Wide Web.

32. The apparatus of claim 1, wherein the apparatus operates at least one of on and over at least one of an RF signal communications network, a satellite communications network, an optical communications network, a public switched telephone network, a digital communications network, and a personal communications services (PCS) communication network.

33. The apparatus of claim 7, wherein the processor identifies the at least two possible travel routes to the destination by taking into account at least one of one-way only streets, two-way streets, and traffic rules, in the area of travel.

34. The apparatus of claim 33, wherein the processor determines the travel distance along each road or street, or segment thereof, for each leg of a travel route for each of the identified possible travel routes.

35. The apparatus of claim 33, wherein the processor identifies intersections along each of the possible travel routes.

36. The apparatus of claim 33, wherein the processor identifies the existence of at least one of traffic control devices, traffic lights, and traffic signals, along a travel route for each of the possible travel routes.

37. The apparatus of claim 7, wherein the processor generates an equation representing at least one of an expected travel time along each of the possible travel routes and an expected travel distance along each of the possible travel routes.

38. The apparatus of claim 37, wherein the equation contains at least one of known quantities and unknown quantities regarding at least one of distance travel distance along a road, street, or intersection, and average travel speed along a road, street, or intersection.

39. The apparatus of claim 37, wherein the processor solves a plurality of equations to determine the optimal travel route.

40. The apparatus of claim 39, wherein the optimal travel route is identified as at least one of the travel route having the minimum travel time, the travel route having the minimum travel distance, and the travel route involving the minimum number of turns.

41. The apparatus of claim 40, wherein the processor identifies the optimal travel route independently of information regarding the operating characteristics of traffic control devices.

42. The apparatus of claim 40, wherein the processor identifies the optimal travel route by utilizing information regarding the operating characteristics of traffic control devices.

43. The apparatus of claim 7, wherein the processor identifies at least two optimal travel routes.

44. The apparatus of claim 1, wherein the apparatus is at least one of a personal computer, a personal communication device, and personal digital assistant.

45. An apparatus for remotely controlling a traffic control device, comprising:
an input device for inputting at least one of a control code and a command code corresponding to a control operation to be performed on a traffic control device;
a processor for processing the at least one of a control code and a command code, wherein the processor generates a first control signal for performing a control operation on the traffic control device; and
a transmitter for transmitting the first control signal to a central processing computer,
wherein the central processing computer processes the first control signal and generates a second control signal, wherein the central processing computer transmits the second control signal to the traffic control device, wherein the traffic control device receives the second control signal and generates a third control signal, wherein the third control signal effectuates the control operation.

46. The apparatus of claim 45, wherein the input device is at least one of a keyboard, a mouse, a user pointing device, and a microphone.

47. The apparatus of claim 45, wherein the apparatus is utilized at least one of on and over the Internet and the World Wide Web.

48. The apparatus of claim 45, wherein the apparatus operates at least one of on and over at least one of an RF signal communications network, a satellite communications network, an optical communications network, a public switched telephone network, a digital communications network, and a personal communications services (PCS) communication network.

49. The apparatus of claim 45, wherein identification information corresponding to the traffic control device is input via the input device.

50. The apparatus of claim 45, wherein the traffic control device is a traffic light, and further wherein the control operation turns a green light on.

51. The apparatus of claim 45, wherein the traffic control device is a traffic light, and further wherein the control operation turns a red light off.

52. The apparatus of claim 45, wherein the traffic control device is a traffic light, and further wherein the control operation turns a green light off.

53. The apparatus of claim 45, wherein the traffic control device is a traffic light, and further wherein the control operation turns a red light on.

54. The apparatus claim 45, further comprising:
a database for storing information regarding a travel area, wherein the information includes at least one of road information, street information, intersection information, and traffic control device information; and
wherein the processor processes a request for information regarding an optimal travel route from a present location of a vehicle to a destination, wherein the processor processes the request by utilizing the information stored in the database, and further wherein the processor identifies at least two possible travel routes to the destination, and further wherein the processor identifies an optimal travel route to the destination, wherein the processor generates a message containing travel directions or instructions corresponding to the optimal travel route; and
an output device for outputting information contained in the message.

55. An apparatus for remotely controlling a traffic control device, comprising:
a receiver for receiving identification information regarding a traffic control device to be controlled and a first control signal corresponding to a control operation to be performed on the traffic control device, wherein the first control signal is received from a vehicle computer located at a vehicle;
a processor for processing the first control signal and for generating a second control signal corresponding to the control operation to be performed on the traffic control device; and
a transmitter for transmitting the second control signal to the traffic control device to be controlled by the second control signal,
wherein the traffic control device processes the second control signal and generates a third control signal, wherein the third control signal effectuates the control operation.

56. The apparatus of claim 55, wherein the traffic control device is a traffic light, and further wherein the control operation turns a green light on.

57. The apparatus of claim 55, wherein the traffic control device is a traffic light, and further wherein the control operation turns a red light off.

58. The apparatus of claim 55, wherein the traffic control device is a traffic light, and further wherein the control operation turns a green light off.

59. The apparatus of claim 55, wherein the traffic control device is a traffic light, and further wherein the control operation turns a red light on.

60. The apparatus claim 55, further comprising:
a database for storing information regarding a travel area, wherein the information includes at least one of road information, street information, intersection information, and traffic control device information; and
wherein the processor processes a request for information regarding an optimal travel route from a present location of a vehicle to a destination, wherein the processor processes the request by utilizing the information stored in the database, and further wherein the processor identifies at least two possible travel routes to the destination, and further wherein the processor identifies an optimal travel route to the destination, wherein the processor generates a message containing travel directions or instructions corresponding to the optimal travel route, and further wherein the transmitter transmits the message to the vehicle computer.

61. The apparatus of claim 55, further comprising:
an input device for inputting at least one of information and commands into the apparatus, wherein the input device includes at least one of a keyboard, a mouse, a user pointing device, and a microphone.

62. The apparatus of claim 55, wherein vehicle present location information and destination information is received from the vehicle computer.

63. The apparatus of claim 55, further comprising:
a display device for displaying information to at least one of an operator.

64. The apparatus of claim 60, wherein the apparatus provides travel information for at least one of an urban area, a suburban area, and a rural area.

65. The apparatus of claim 60, wherein the optimal travel route involves the minimum travel time to the destination.

66. The apparatus of claim 60, wherein the optimal travel route involves the minimum travel distance to a destination.

67. The apparatus of claim 60, wherein the optimal travel route involves the minimum number of turns along a travel route to a destination.

68. The apparatus of claim 61, wherein the input device includes a microphone for receiving voice information regarding at least one of a control code, a command code, command, vehicle present location information, and destination information.

69. The apparatus of claim 60, wherein the processor identifies the optimal travel route independently of information regarding the operating characteristics of traffic control devices located along the at least two possible travel routes to the destination.

70. The apparatus of claim 55, wherein the traffic control device includes at least one traffic light, and further wherein operating characteristics of the traffic control device includes at least one of green light on time, green light on time schedule, and green light on time duration.

71. The apparatus of claim 60, wherein the processor identifies the optimal travel route by utilizing information regarding the operating characteristics of traffic control devices located along the at least two possible travel routes to the destination.

72. The apparatus of claim 71, wherein the traffic control device includes at least one traffic light, and further wherein the operating characteristics of the traffic control device includes at least one of green light on time, green light on time schedule, and green light on time duration.

73. The apparatus of claim 60, wherein the database contains at least one of map information, digitized map information, geographical map information, area map information, road information, street information, road location information, street location information, road position information, street position information, intersection information, intersection location, intersection position information, direction of travel information, allowed speed of travel information, allowed turning information, length of a road or street, distance between intersections on a road or street, traffic control devices on a road, street, or intersection, pre-stored travel route information, pre-stored alternate travel route information, pre-stored route travel distance information, average speed of travel information, information regarding the on times and off times of traffic control devices, observed average speed of travel of vehicles on a road, street, or intersection, average vehicle stop time at a traffic control device, distance of travel along a road, a street, or a segment thereof, between intersections, the distance of travel through an intersection, the distance of travel along a segment of a road or street in the vicinity of a traffic control device, and observed or estimated average speed of travel.

74. The apparatus of claim 60, wherein the information stored in the database can be at least one of resident in the database and obtained from at least one of a compact disc (CD), a digital versatile disc (DVD), a magnetic tape, and a storage medium.

75. The apparatus of claim 55, further comprising:
database for storing information regarding at least one traffic control device, identification information for at least one traffic control device, information for processing the at least one of a control code and a command code, and information for remotely controlling the traffic control device.

76. The apparatus of claim 55, wherein the apparatus operates in a network environment.

77. The apparatus of claim 55, wherein the apparatus operates at least one of on and over at least one of the Internet and the World Wide Web.

78. The apparatus of claim 55, wherein the apparatus operates at least one of on and over at least one of an RF signal communications network, a satellite communications network, an optical communications network, a public switched telephone network, a digital communications network, and a personal communications services (PCS) communication network.

79. The apparatus of claim 60, wherein the processor identifies the at least two possible travel routes to the destination by taking into account at least one of one-way only streets, two-way streets, and traffic rules, in the area of travel.

80. The apparatus of claim 79, wherein the processor determines the travel distance along each road or street, or segment thereof, for each leg of a travel route for each of the identified possible travel routes.

81. The apparatus of claim 79, wherein the processor identifies intersections along each of the possible travel routes.

82. The apparatus of claim 79, wherein the processor identifies the existence of at least one of traffic control devices, traffic lights, and traffic signals, along a travel route for each of the possible travel routes.

83. The apparatus of claim 60, wherein the processor generates an equation representing at least one of an expected travel time along each of the possible travel routes and an expected travel distance along each of the possible travel routes.

84. The apparatus of claim 83, wherein the equation contains at least one of known quantities and unknown quantities regarding at least one of distance travel distance along a road, street, or intersection, and average travel speed along a road, street, or intersection.

85. The apparatus of claim 79, wherein the processor solves a plurality of equations to determine the optimal travel route.

86. The apparatus of claim 85, wherein the optimal travel route is identified as at least one of the travel route having the minimum travel time, the travel route having the minimum travel distance, and the travel route involving the minimum number of turns.

87. The apparatus of claim 86, wherein the processor identifies the optimal travel route independently of information regarding the operating characteristics of traffic control devices.

88. The apparatus of claim 86, wherein the processor identifies the optimal travel route by utilizing information regarding the operating characteristics of traffic control devices.

89. The apparatus of claim 60, wherein the processor identifies at least two optimal travel routes.

90. The apparatus of claim 55, wherein the apparatus is at least one of a central processing computer, a server computer, and an Internet server computer.

91. The apparatus of claim 1, wherein the apparatus automatically generates and transmits the first control signal to the traffic control device.

92. The apparatus of claim 91, wherein the apparatus detects an operating state of the traffic control device.

93. The apparatus of claim 45, wherein the apparatus automatically generates and transmits the first control signal to the central processing computer.

94. The apparatus of claim 45, wherein the apparatus detects an operating state of the traffic control device.

95. The apparatus of claim 45, wherein the processor automatically generates and transmits the second control signal to the traffic control device.

96. The apparatus of claim 55, wherein the apparatus automatically receives the first control signal, automatically generates the second control signal, and automatically transmits the second control signal to the traffic control device.

97. The apparatus of claim 55, wherein the apparatus detects an operating state of the traffic control device.

98. An apparatus for facilitating a remote control of a traffic control device from a vehicle, comprising:
a traffic control element;
a receiver for receiving a control signal for controlling an operation of the traffic control element; and
a processor for processing the control signal, wherein the processor generates a second control signal which effectuates a control operation on the traffic control element.

99. The apparatus of claim 98, wherein the apparatus is a traffic control device.

100. The apparatus of claim 99, wherein the traffic control device is a traffic light, a stop light, a flashing light, and a message display device.

101. The apparatus of claim 98, wherein the control signal is received from at least one of a vehicle computer located at a vehicle and a central processing computer.

102. The apparatus of claim 98, wherein the operation of the traffic control element to be controlled is at least one of turning a red light off, turning a green light on, turning a red light on, and turning a green light off.

103. The apparatus of claim 98, wherein the receiver receives an operating state request message from at least one of a vehicle computer and a central processing computer, wherein the processor determines the operating state of the traffic control element and generates a reply message, and further wherein the apparatus further comprises:
a transmitter for transmitting the reply message to the at least one of a vehicle computer and a central processing computer.

104. A method for remotely controlling a traffic control device, comprising:
inputting at least one of a control code and a command code corresponding to a control operation to be performed on a traffic control device into an input device;
processing the at least one of a control code and a command code;
generating a first control signal for performing a control operation on the traffic control device; and
transmitting the first control signal to the traffic control device, wherein the traffic control device receives the first control signal and generates a second control signal, wherein the second control signal effectuates the control operation.

105. The method of claim 104, further comprising:
inputting identification information corresponding to the traffic control device.

106. The method of claim 104, wherein the traffic control device is a traffic light, and further wherein the control operation turns a green light on.

107. The method of claim 104, wherein the traffic control device is a traffic light, and further wherein the control operation turns a red light off.

108. The method of claim 104, wherein the traffic control device is a traffic light, and further wherein the control operation turns a green light off.

109. The method of claim 104, wherein the traffic control device is a traffic light, and further wherein the control operation turns a red light on.

110. The method of claim 104, further comprising:
storing information regarding a travel area, wherein the information includes at least one of road information, street information, intersection information, and traffic control device information;
processing a request for information regarding an optimal travel route from a present location of a vehicle to a destination;
identifying at least two possible travel routes to the destination;
identifying an optimal travel route to the destination;
generating a message containing travel directions or instructions corresponding to the optimal travel route; and
outputting information contained in the message.

111. The method of claim 104, wherein the input device includes at least one of a keyboard, a mouse, a user pointing device, and a microphone.

112. The method of claim 110, wherein vehicle present location information and destination information is input.

113. The method of claim 104, further comprising:
determining the vehicle present location information.

114. The method of claim 104, further comprising:
inputting at least one of a command, vehicle present location information, and destination information; and
determining vehicle present location information.

115. The method of claim 104, further comprising:
displaying information to at least one of a vehicle operator or occupant.

116. The method of claim 110, further comprising:
displaying information contained in the message to at least one of the vehicle operator and occupant.

117. The method of claim 110, further comprising:
generating voice information corresponding to the information contained in the message.

118. The method of claim 110, wherein the method provides travel information for at least one of an urban area, a suburban area, and a rural area.

119. The method of claim 110, wherein the optimal travel route involves the minimum travel time to the destination.

120. The method of claim 104, wherein the optimal travel route involves the minimum travel distance to a destination.

121. The method of claim 110, wherein the optimal travel route involves the minimum number of turns along a travel route to a destination.

122. The method of claim 110, further comprising:
identifying the optimal travel route independently of information regarding the operating characteristics of traffic control devices located along the at least two possible travel routes to the destination.

123. The method of claim 104, wherein the traffic control device includes at least one traffic light, and further wherein operating characteristics of the traffic control device includes at least one of green light on time, green light on time schedule, and green light on time duration.

124. The method of claim 110, further comprising:
identifying the optimal travel route by utilizing information regarding the operating characteristics of traffic control devices located along the at least two possible travel routes to the destination.

125. The method of claim 124, wherein the traffic control device include at least one traffic light, and further wherein the operating characteristics of the traffic control device include at least one of green light on time, green light on time schedule, and green light on time duration.

126. The method of claim 110, wherein the stored information includes at least one of map information, digitized map information, geographical map information, area map information, road information, street information, road location information, street location information, road position information, street position information, intersection information, intersection location, intersection position information, direction of travel information, allowed speed of travel information, allowed turning information, length of a road or street, distance between intersections on a road or street, traffic control devices on a road, street, or intersection, pre-stored travel route information, pre-stored alternate travel route information, pre-stored route travel distance information, average speed of travel information, information regarding the on times and off times of traffic control devices, observed average speed of travel of vehicles on a road, street, or intersection, average vehicle stop time at a traffic control device, distance of travel along a road, a street, or a segment thereof, between intersections, the distance of travel through an intersection, the distance of travel along a segment of a road or street in the vicinity of a traffic control device, and observed or estimated average speed of travel.

127. The method of claim 110, wherein the stored information can be at least one of resident in the database and obtained from at least one of a compact disc (CD), a digital versatile disc (DVD), a magnetic tape, and a storage medium.

128. The method of claim 104, further comprising:
storing information regarding at least one traffic control device, identification information for at least one traffic control device, information for processing the at least one of a control code and a command code, and information for remotely controlling the traffic control device.

129. The method of claim 104, further comprising:
transmitting vehicle present location information and destination information to a central processing computer; and
receiving a message containing travel directions or instructions corresponding to an optimal travel route to a destination from the central processing computer.

130. The method of claim 104, wherein the method is utilized in a network environment.

131. The method of claim 104, wherein the method is utilized at least one of on and over at least one of the Internet and the World Wide Web.

132. The method of claim 104, wherein the method is utilized at least one of on and over at least one of an RF signal communications network, a satellite communications network, an optical communications network, a public switched telephone network, a digital communications network, and a personal communications services (PCS) communication network.

133. The method of claim 110, further comprising:
identifying the at least two possible travel routes to the destination by taking into account at least one of one-way only streets, two-way streets, and traffic rules, in the area of travel.

134. The method of claim 133, further comprising:
determining the travel distance along each road or street, or segment thereof, for each leg of a travel route for each of the identified possible travel routes.

135. The apparatus of claim 133, wherein the processor identifies intersections along each of the possible travel routes.

136. The apparatus of claim 133, further comprising:
identifying the existence of at least one of traffic control devices, traffic lights, and traffic signals, along a travel route for each of the possible travel routes.

137. The method of claim 110, further comprising:
generating an equation representing at least one of an expected travel time along each of the possible travel routes and an expected travel distance along each of the possible travel routes.

138. The method of claim 137, wherein the equation contains at least one of known quantities and unknown quantities regarding at least one of distance travel distance along a road, street, or intersection, and average travel speed along a road, street, or intersection.

139. The apparatus of claim 137, further comprising:
solving a plurality of equations to determine the optimal travel route.

140. The method of claim 139, wherein the optimal travel route is identified as at least one of the travel route having the minimum travel time, the travel route having the minimum travel distance, and the travel route involving the minimum number of turns.

141. The apparatus of claim 140, further comprising:
identifying the optimal travel route independently of information regarding the operating characteristics of traffic control devices.

142. The apparatus of claim 140, further comprising:
identifying the optimal travel route by utilizing information regarding the operating characteristics of traffic control devices.

143. The method of claim 109, further comprising:
identifying at least two optimal travel routes.

144. The method of claim 103, wherein the method is utilized in conjunction with at least one of a personal computer, a personal communication device, and personal digital assistant.

145. A method for remotely controlling a traffic control device, comprising:
inputting at least one of a control code and a command code corresponding to a control operation to be performed on a traffic control device into an input device;
processing the at least one of a control code and a command code;
generating a first control signal for performing a control operation on the traffic control device; and
transmitting the first control signal to a central processing computer,
wherein the central processing computer processes the first control signal and generates a second control signal, wherein the central processing computer transmits the second control signal to the traffic control device, wherein the traffic control device receives the second control signal and generates a third control signal, wherein the third control signal effectuates the control operation.

146. The method of claim 145, wherein the input device is at least one of a keyboard, a mouse, a user pointing device, and a microphone.

147. The method of claim 145, wherein the method is utilized at least one of on and over the Internet and the World Wide Web.

148. The method of claim 145, wherein the method in utilized at least one of on and over at least one of an RF signal communications network, a satellite communications network, an optical communications network, a public switched telephone network, a digital communications network, and a personal communications services (PCS) communication network.

149. The method of claim 145, further comprising:
inputting identification information corresponding to the traffic control device.

150. The method of claim 145, wherein the traffic control device is a traffic light, and further wherein the control operation turns a green light on.

151. The method of claim 145, wherein the traffic control device is a traffic light, and further wherein the control operation turns a red light off.

152. The method of claim 145, wherein the traffic control device is a traffic light, and further wherein the control operation turns a green light off.

153. The method of claim 145, wherein the traffic control device is a traffic light, and further wherein the control operation turns a red light on.

154. The method of claim 145, further comprising:
storing information regarding a travel area, wherein the information includes at least one of road information, street information, intersection information, and traffic control device information;
processing a request for information regarding an optimal travel route from a present location of a vehicle to a destination,
identifying at least two possible travel routes to the destination;
identifying an optimal travel route to the destination;
generating a message containing travel directions or instructions corresponding to the optimal travel route; and
outputting information contained in the message.

155. A method for remotely controlling a traffic control device, comprising:
receiving identification information regarding a traffic control device to be controlled and a first control signal corresponding to a control operation to be performed on the traffic control device, wherein the first control signal is received from a vehicle computer located at a vehicle;
processing the first control signal;
generating a second control signal corresponding to the control operation to be performed on the traffic control device; and
transmitting the second control signal to the traffic control device to be controlled by the second control signal,
wherein the traffic control device processes the second control signal and generates a third control signal, wherein the third control signal effectuates the control operation.

156. The method of claim 155, wherein the traffic control device is a traffic light, and further wherein the control operation turns a green light on.

157. The method of claim 155, wherein the traffic control device is a traffic light, and further wherein the control operation turns a red light off.

158. The method of claim 155, wherein the traffic control device is a traffic light, and further wherein the control operation turns a green light off.

159. The method of claim 155, wherein the traffic control device is a traffic light, and further wherein the control operation turns a red light on.

160. The method of claim 155, further comprising:
storing information regarding a travel area, wherein the information includes at least one of road information, street information, intersection information, and traffic control device information;
processing a request for information regarding an optimal travel route from a present location of a vehicle to a destination;
processing the request by utilizing the information stored in the database;
identifying at least two possible travel routes to the destination;
identifying an optimal travel route to the destination;
generating a message containing travel directions or instructions corresponding to the optimal travel route; and
transmitting the message to the vehicle computer.

161. The method of claim 155, further comprising:
receiving vehicle present location information from the vehicle computer.

162. The method of claim 155, further comprising:
displaying information to at least one of an operator.

163. The method of claim 160, wherein the method provides travel information for at least one of an urban area, a suburban area, and a rural area.

164. The method of claim 160, wherein the optimal travel route involves the minimum travel time to the destination.

165. The method of claim 160, wherein the optimal travel route involves the minimum travel distance to a destination.

166. The method of claim 160, wherein the optimal travel route involves the minimum number of turns along a travel route to a destination.

167. The method of claim 160, further comprising:
identifying the optimal travel route independently of information regarding the operating characteristics of traffic control devices located along the at least two possible travel routes to the destination.

168. The method of claim 155, wherein the traffic control device includes at least one traffic light, and further wherein operating characteristics of the traffic control device includes at least one of green light on time, green light on time schedule, and green light on time duration.

169. The method of claim 160, further comprising:
identifying the optimal travel route by utilizing information regarding the operating characteristics of traffic control devices located along the at least two possible travel routes to the destination.

170. The method of claim 169, wherein the traffic control device includes at least one traffic light, and further wherein the operating characteristics of the traffic control device includes at least one of green light on time, green light on time schedule, and green light on time duration.

171. The method of claim 160, wherein the stored information includes at least one of map information, digitized map information, geographical map information, area map information, road information, street information, road location information, street location information, road position information, street position information, intersection information, intersection location, intersection position information, direction of travel information, allowed speed of travel information, allowed turning information, length of a road or street, distance between intersections on a road or street, traffic control devices on a road, street, or intersection, pre-stored travel route information, pre-stored alternate travel route information, pre-stored route travel distance information, average speed of travel information, information regarding the on times and off times of traffic control devices, observed average speed of travel of vehicles on a road, street, or intersection, average vehicle stop time at a traffic control device, distance of travel along a road, a street, or a segment thereof, between intersections, the distance of travel through an intersection, the distance of travel along a segment of a road or street in the vicinity of a traffic control device, and observed or estimated average speed of travel.

172. The method of claim 160, wherein the stored information can be at least one of resident in the database and obtained from at least one of a compact disc (CD), a digital versatile disc (DVD), a magnetic tape, and a storage medium.

173. The method of claim 155, further comprising:
storing information regarding at least one traffic control device, identification information for at least one traffic control device, information for processing the at least one of a control code and a command code, and information for remotely controlling the traffic control device.

174. The method of claim 155, wherein the method is utilized in a network environment.

175. The method of claim 155, wherein the method is utilized at least one of on and over at least one of the Internet and the World Wide Web.

176. The apparatus of claim 155, wherein the method is utilized at least one of on and over at least one of an RF signal communications network, a satellite communications network, an optical communications network, a public switched telephone network, a digital communications network, and a personal communications services (PCS) communication network.

177. The method of claim 160, further comprising:
identifying the at least two possible travel routes to the destination by taking into account at least one of one-way only streets, two-way streets, and traffic rules, in the area of travel.

178. The method of claim 177, further comprising:
determining the travel distance along each road or street, or segment thereof, for each leg of a travel route for each of the identified possible travel routes.

179. The method of claim 177, further comprising:
identifying intersections along each of the possible travel routes.

180. The method of claim 177, further comprising:
identifying the existence of at least one of traffic control devices, traffic lights, and traffic signals, along a travel route for each of the possible travel routes.

181. The method of claim 160, further comprising:
generating an equation representing at least one of an expected travel time along each of the possible travel routes and an expected travel distance along each of the possible travel routes.

182. The method of claim 181, wherein the equation contains at least one of known quantities and unknown quantities regarding at least one of distance travel distance along a road, street, or intersection, and average travel speed along a road, street, or intersection.

183. The method of claim 181, further comprising:
solving a plurality of equations to determine the optimal travel route.

184. The method of claim 183, wherein the optimal travel route is identified as at least one of the travel route having the minimum travel time, the travel route having the minimum travel distance, and the travel route involving the minimum number of turns.

185. The method of claim 184, further comprising:
identifying the optimal travel route independently of information regarding the operating characteristics of traffic control devices.

186. The method of claim 184, further comprising:
identifying the optimal travel route by utilizing information regarding the operating characteristics of traffic control devices.

187. The method of claim 160, further comprising:
identifying at least two optimal travel routes.

188. The method of claim 155, wherein the method is utilized in conjunction with at least one of a central processing computer, a server computer, and an Internet server computer.

189. The method of claim 103, further comprising:
automatically generating and transmitting the first control signal to the traffic control device.

190. The method of claim 189, further comprising:
detecting an operating state of the traffic control device.

191. The method of claim 145, further comprising:
automatically generating and transmitting the first control signal to the central processing computer.

192. The method of claim 145, further comprising:
detecting an operating state of the traffic control device.

193. The method of claim 145, further comprising:
automatically generating and transmitting the second control signal to the traffic control device.

194. The method of claim 155, further comprising:
automatically receiving the first control signal;
automatically generating the second control signal; and
automatically transmitting the second control signal to the traffic control device.

195. The method of claim 155, further comprising:
detecting an operating state of the traffic control device.

196. A method for facilitating a remote control of a traffic control device from a vehicle, comprising:
receiving a control signal for controlling an operation of a traffic control element; and
processing the control signal; and
generating a second control signal which effectuates a control operation on the traffic control element.

197. The method of claim 196, wherein the traffic control element is a component of a traffic control device.

198. The method of claim 197, wherein the traffic control device is a traffic light, a stop light, a flashing light, and a message display device.

199. The method of claim 196, wherein the control signal is received from at least one of a vehicle computer located at a vehicle and a central processing computer.

200. The method of claim 196, wherein the operation of the traffic control element to be controlled is at least one of turning a red light off, turning a green light on, turning a red light on, and turning a green light off.

201. The method of claim 196, further comprising:
receiving an operating state request message from at least one of a vehicle computer and a central processing computer;
determining the operating state of the traffic control element;
generating a reply message; and
transmitting the reply message to the at least one of a vehicle computer and a central processing computer.
